(19) United States
(12) Patent Application Publication
(10) Pub. No.: US 2026/0037997 A1
(43) Pub. Date: Feb. 5, 2026

(54) METHODS AND SYSTEMS FOR DETERMINING QUALITY OF MEDIA CONTENT

(71) Applicant: Zoodiker, Inc., Los Angeles, CA (US)

(72) Inventors: Robert Tzudiker, Los Angeles, CA (US); Leilah Franklin, Los Angeles, CA (US); Raymond Toal, Glendale, CA (US); John Dionisio, Los Angeles, CA (US); William Thompson, South Burlington, VT (US); Story Haas, Columbus, OH (US)

(21) Appl. No.: 19/284,530

(22) Filed: Jul. 29, 2025

Related U.S. Application Data
(60) Provisional application No. 63/677,213, filed on Jul. 30, 2024.

(51) Int. Cl. G06Q 30/0203; G06F 40/40

(52) U.S. Cl. CPC G06Q 30/0203; G06F 40/40

(57) ABSTRACT

Methods and systems for determining quality of media content are disclosed. The method performed by a server system includes extracting textual data related to a screenplay associated with media content being produced by a first user. Method includes segmenting the textual data into multiple sections to display each section to second user(s). Method includes receiving user input(s) from each of the second user(s) for each section. Method includes determining, by Machine Learning (ML) model(s) associated with the server system, user behavior of each second user, and a set of interpretations for the screenplay based on the textual data and user input(s). Method includes generating, by the ML model(s), a prediction indicative of a predicted quality of the media content based on the user behavior and the set of interpretations.

### TECHNICAL FIELD

The present disclosure relates to the field of data mining and analysis and, more particularly, to methods and systems for determining the quality of media content.

### BACKGROUND

Media content, such as films, Television (TV) series, podcasts, webcasts, and similar content, is typically produced for entertainment and/or educational purposes. Test screening of such media content is an important step carried out by content creators before releasing the media content or recorded content to the public. As used herein, the term ‘test screening’ refers to a preview screening of the recorded content conducted to assess audience reactions. Participants are generally selected from a population and are requested to submit feedback, often through questionnaires. The production of media content is inherently capital-intensive and involves significant financial risk. Conventionally, the content creators have to wait for test screenings of the completed media content (e.g., wrapped-up films) to measure audience sentiments. At this stage, over 90% of the capital has typically been invested and is in jeopardy. Further, adverse audience feedback at this point often necessitates re-edits or re-shoots, and they are typically expensive and time-consuming.

To address the above-mentioned issues, multiple approaches have been implemented by several companies. Some of the approaches perform a retrospective analysis of previously recorded films that share similar story attributes with a screenplay under evaluation. Such approaches involve manual inputs from human readers filling out a sheet that divides the story in the screenplay into genres and sub-genres. These attributes are compared to the historical box office data of similar films to make a prediction for the current project.

Further, some companies implemented Artificial Intelligence (AI) for the analysis of results following manual categorization of the existing script. However, AI-driven methods are predominantly retrospective in nature. This indicates that the databases do not accurately reflect the likes and sensitivities of the audience today because they are based on movies from the past, sometimes from decades ago. Another drawback of these approaches is that the systems are built upon rigid conceptual frameworks of genre and story parts, often originating from academic formulations lacking empirical validation. Additionally, genres recombine and change continually. It is therefore understandable that the most recent systematized analyses lack sufficient up-to-date data. Yet another drawback is transparency. The rationale is that the analysis of the screenplay conducted by AI is vaporware, and the sources of the data are not disclosed. Moreover, the AI lacks the comprehensive ability to recognize emotions, evaluate the quality of digital information, or establish a human connection.

Consequently, several companies continue to employ script readers and story analysts individually to summarize and evaluate scripts manually. However, such companies still lack audience-level responses and data-driven analyses. However, systems associated with such approaches fail to predict whether the audience will connect with the script or not. The reason is that AI is capable of determining whether the current script is similar to any of a previous set of works, rather than providing a real human-like opinion of the current script.

Therefore, a technological need exists for methods and systems for determining a quality of media content with better efficiency in terms of time and financial expenses.

### SUMMARY

Various embodiments of the present disclosure provide methods and systems for determining a quality of media content.

In an embodiment, a computer-implemented method for determining a quality of media content is disclosed. The computer-implemented method performed by a server system includes extracting textual data related to a screenplay associated with media content being produced by a first user. The computer-implemented method further includes segmenting the textual data into a plurality of sections. Herein, each section of the plurality of sections is displayed to a plurality of second users. Furthermore, the computer-implemented method includes receiving one or more user inputs from each of the plurality of second users for each respective section. Moreover, the computer-implemented method includes determining, by one or more Machine Learning (ML) models associated with the server system, user behavior corresponding to each second user of the plurality of second users and a set of interpretations related to the screenplay based, at least in part, on the textual data and the one or more user inputs. The computer-implemented method further includes generating, by the one or more ML models, a prediction indicative of a predicted quality of the media content based, at least in part, on the user behavior and the set of interpretations.

In another embodiment, a server system is disclosed. The server system includes a communication interface and a memory including executable instructions. The server system also includes a processor communicably coupled to the memory. The processor is configured to execute the instructions to cause the server system, at least in part, to extract textual data related to a screenplay associated with media content being produced by a first user. The server system is further caused to segment the textual data into a plurality of sections. Herein, each section of the plurality of sections is displayed to a plurality of second users. Further, the server system is caused to receive one or more user inputs from each of the plurality of second users for each respective section of the plurality of sections. Thereafter, the server system is caused to determine, by one or more Machine Learning (ML) models associated with the server system, user behavior corresponding to each second user of the plurality of second users and a set of interpretations related to the screenplay based, at least in part, on the textual data and the one or more user inputs. Moreover, the server system is caused to generate, by the one or more ML models, a prediction indicative of a predicted quality of the media content based, at least in part, on the user behavior and the set of interpretations.

In yet another embodiment, a non-transitory computer-readable storage medium is disclosed. The non-transitory computer-readable storage medium includes computer-executable instructions that, when executed by at least a processor of a server system, cause the server system to perform a method. The method includes extracting textual data related to a screenplay associated with media content being produced by a first user. The method further includes segmenting the textual data into a plurality of sections. Herein, each section of the plurality of sections is displayed to a plurality of second users. Furthermore, the method includes receiving one or more user inputs from each of the plurality of second users for each respective section. Moreover, the method includes determining, by one or more Machine Learning (ML) models associated with the server system, user behavior corresponding to each second user of the plurality of second users and a set of interpretations related to the screenplay based, at least in part, on the textual data and the one or more user inputs. The method further includes generating, by the one or more ML models, a prediction indicative of a predicted quality of the media content based, at least in part, on the user behavior and the set of interpretations.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment related to at least some example embodiments of the present disclosure;

FIG. 2 illustrates a simplified block diagram of a server system, in accordance with an embodiment of the present disclosure;

FIG. 3 illustrates a schematic representation of a workflow for determining a quality of media content, in accordance with an embodiment of the present disclosure;

FIG. 4A illustrates a graphical representation of a comparison of a reader's rating with test screening data, in accordance with an embodiment of the present disclosure;

FIG. 4B illustrates a graphical representation of a failure analysis indicating a drop-off by age, in accordance with an embodiment of the present disclosure;

FIG. 4C illustrates a graphical representation of the failure analysis indicating a drop-off by gender, in accordance with an embodiment of the present disclosure;

FIG. 5 illustrates a User Interface (UI) displayed to one or more second users, in accordance with an embodiment of the present disclosure;

FIG. 6A illustrates a graphical representation of a variation of momentum indicating an engagement of a second user with a screenplay, in accordance with an embodiment of the present disclosure;

FIG. 6B illustrates a graphical representation of behavior of the one or more second users interested in reading the screenplay after each pause, in accordance with an embodiment of the present disclosure;

FIG. 6C illustrates a graphical representation of frequency of pauses with respect to a page reading time of the screenplay, in accordance with an embodiment of the present disclosure;

FIG. 6D illustrates a graphical representation of the distribution of average pause time with respect to each page in the screenplay, in accordance with an embodiment of the present disclosure;

FIG. 6E illustrates a graphical representation of results of a pause time significant test, in accordance with an embodiment of the present disclosure;

FIG. 6F illustrates a graphical representation of the results of the pause time significant test, in accordance with another embodiment of the present disclosure;

FIG. 7 illustrates a graphical representation of a pause plus momentum plot, in accordance with an embodiment of the present disclosure;

FIG. 8A illustrates a graphical representation of the centrality of characters in the screenplay, in accordance with an embodiment of the present disclosure;

FIG. 8B illustrates a graphical representation of a character network in the screenplay, in accordance with an embodiment of the present disclosure;

FIG. 8C illustrates a graphical representation of character centrality versus appeal in the screenplay, in accordance with an embodiment of the present disclosure;

FIG. 8D illustrates a graphical representation of character total lines versus appeal in the screenplay, in accordance with an embodiment of the present disclosure;

FIG. 8E illustrates a graphical representation of probability of mention versus average rating for a particular character in the screenplay, in accordance with an embodiment of the present disclosure;

FIG. 8F illustrates a graphical representation of an effect of character presence on page rating in the screenplay, in accordance with an embodiment of the present disclosure;

FIG. 8G illustrates a graphical representation of character activity of one or more characters in the screenplay, in accordance with an embodiment of the present disclosure;

FIG. 8H illustrates a graphical representation of character incidence per page of one or more characters in the screenplay, in accordance with an embodiment of the present disclosure;

FIG. 9 illustrates a flow diagram depicting a method for determining a quality of media content, in accordance with an embodiment of the present disclosure; and

FIG. 10 illustrates a flowchart depicting a method for determining a quality of media content, in accordance with an embodiment of the present disclosure

The drawings referred to in this description are not to be understood as being drawn to scale, except if specifically noted, and such drawings are only of an example in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described that may be exhibited by some embodiments and not by others. Similarly, various requirements are described, which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The terms “media content”, “recorded content”, “content”, and “recorded media content” have been used interchangeably throughout the description and generally refer to any form of information, entertainment, or communication that is created and distributed through various media platforms. The media content can include text, audio, images, video, animations, or a combination of these. The media content is essentially what people consume via Television (TV), radio, newspapers, websites, social media, streaming platforms, and other digital or traditional media channels.

The terms “preview screening” and “test screening” have been used interchangeably throughout the description and generally refer to a private showing of a movie, TV episode, or other filmed content to a select audience before its official release. The main purpose is to gather feedback from viewers to understand how the audience reacts to different aspects of the film, such as the story, characters, pacing, or ending, so that adjustments can be made if needed.

The terms “screenplay” and “script” have been used interchangeably throughout the description and generally refer to a written document which is written in a specific format including scene headings, action descriptions, and character dialogue for a movie or TV show. Screenplays are written by screenwriters and are essential for translating a story from the written word to the screen effectively.

The “preview audience” refers to a group of selected individuals who are invited to watch a movie, TV show, or other filmed content before its official public release. This audience typically participates in a preview screening to provide feedback on the media content.

The terms “content viewers”, “audience”, “end users”, “public”, “viewers”, and “consumers” have been used interchangeably throughout the description and generally refer to a group of people who watch, listen to, read, or otherwise consume a piece of content. This piece of content can be for entertainment, information, education, or other purposes, and the content can be in any format, such as video, audio, text, or live performance.

### Overview

Various embodiments of the present disclosure provide methods and systems quality of media content. In a non-limiting implementation, the server system is configured to perform a reader behavior analysis for a screenplay. Herein, the screenplay may be associated with the media content that is being produced by a content creator, such as a first user. Prior to preparing the media content, the screenplay is reviewed and tested for its quality using the server system proposed in the present disclosure. For reviewing the screenplay, readers such as a plurality of second users are hired or recruited.

In an embodiment, the reader behavior analysis can include computing a reading speed of each reader such as a second user, and identifying those significantly deviating from the norm. In another embodiment, the reader behavior analysis further includes determining pauses made by the second users while reading the screenplay. More specifically, the server system can detect pauses based on time spent on a section, considering section length and content complexity. Further, the server system may analyze pause patterns using statistical models (e.g., ARIMA) to identify significant clusters of pauses. Thereafter, the server system may correlate pauses with reader responses and comments.

Further, in an embodiment, the reader behavior analysis also includes determining a momentum (or story momentum) of the story in the screenplay. More specifically, the server system can generate a “momentum” score for each section based on page-turn responses. Further, the server system can track momentum changes throughout the screenplay.

Furthermore, in an embodiment, the reader behavior analysis can include determining a drop-off associated with the screenplay. More specifically, the server system can identify sections where readers such as the second users, abandon the screenplay. Further, the server system can analyze drop-off rates in relation to reader demographics and screenplay content.

In some embodiments, the server system is further configured to perform a character analysis. In a non-limiting implementation, the character analysis can be performed by the server system based at least on constructing a character network, where nodes represent characters and edges represent their interactions (co-occurrences in scenes). Further, the server system may calculate character centrality (e.g., Eigenvector Centrality) to identify influential characters. Thereafter, the server system can determine character importance based on centrality. Then, the server system can analyze the relationship between character presence, reader responses, and momentum.

In addition, the server system can assess character appeal based on reader feedback and engagement as a part of the process of character analysis. Further, the server system can quantify character activity by measuring character density on each page. Thereafter, the server system can analyze character incidence per page and compare dialogue intensity patterns. In an embodiment, the server system can use NLP techniques (including ML models) to analyze free-form comments and determine reader sentiment (positive, negative, neutral) for each section and the screenplay as a whole. Further, the server system may identify key themes and recurring issues from the comments and correlate sentiment with momentum, pauses, and character analysis. Moreover, the server system may summarize reader comments and analyze clusters of comments.

In some other embodiments, the server system is further configured to perform statistical analysis. In a non-limiting implementation, the statistical analysis can include performing statistical tests (e.g., ANOVA, t-tests) to identify significant differences in reader responses and behavior across demographic groups using the server system. This process can include configuring the server system to calculate P-values to determine the statistical significance of findings. Further, the server system may use linear regression to model the relationship between character presence and audience ratings.

To that end, the server system may generate an output including a report to the content creator, i.e., the first user. The report can include the following parameters:
a. The overall screenplay quality score.
b. Detailed analysis of reader behavior, character dynamics, and sentiment.
c. Identification of strengths and weaknesses in the screenplay.
d. Specific recommendations for improvement.
e. Identification of specific story strengths or weaknesses within reader demographics as a predictive tool for audience responses to the completed film.

To conclude, it may be understood that the key considerations for the implementation of the server system can be that the algorithm is continuously refined based on feedback and validation with actual audience (e.g., third users) responses to the finished media content. Further, the weighting of different factors in the scoring system of the server system may need to be adjusted depending on the genre and target audience of the screenplay.

Various embodiments of the present disclosure offer multiple advantages and technical effects. For instance, the present disclosure introduces innovative methodologies and technologies for determining the quality of the media content at early stages, i.e., when the screenplay is being prepared. As may be understood, the key problem is that the filmed entertainment industry relies on screenplays to make creative and business decisions without any hard data on how their likely audience will respond to the story. This means investment decisions are made based on gut feelings and opinions based on past performance. The unique methods and analyses of reader responses proposed in the present disclosure provide a more solid basis for decisions before major investments are made, and while there is still time to fix problems on paper, rather than after spending an amount in millions on filming.

Moreover, it is to be noted that the basis of the analyses proposed in the present disclosure is on the reactions of a statistically significant number of readers. This keeps the reports generated using the proposed approach up to date with preferences and sensitivities. Further, since there is no usage of preconceived notions of story structure or formulas or black box analyses, the proposed approach is a highly efficient and reliable approach that can generate highly accurate results.

Furthermore, the proposed approach is a new tool for media content such as filmed entertainment, aiming to streamline the script development process, provide decision support for investments, and avoid costly story errors and even more costly box office disasters. The proposed approach can predict whether a particular story can connect with its future audience at the screenplay stage itself. As a result, the same metrics and demographics may be provided that one gets from a test screening of a completed film. To that end, it is understood that the processing resources and time consumption required for the implementation of the proposed approach are less in comparison to conventional approaches that perform test screening. This contributes to the technical advancement and technical effect of the proposed approach as the recording of the media content is not required, re-recording or re-shooting of the media content is not required (which was the case for test screening of the media content) and a mere script is sufficient for the implementation of the proposed approach. Moreover, if the story fails to connect, the proposed approach can provide the reasoning associated with such a situation. This contributes to additional technical benefits of the proposed approach.

In addition, the proposed approach provides the information such as the quality of the media content (i.e., the filmed entertainment) at a much earlier stage of the process, when intervention is relatively cheap, resource-efficient, and more effective (writing is always cheaper than reshooting). Further, the proposed approach applies statistical analyses to the readers' responses, behaviors, and demographics to provide an early look at the future audience response. The advantages are several, including getting timely responses from a statistically significant number of readers for up-to-date audience sentiment, making the proposed approach technically advanced in comparison to conventional approaches.

In other words, the proposed approach provides an integrated system for script evaluation through structured feedback collection, reader behavior analysis, and objective content segmentation. For instance, the system is designed to serve as an end-to-end digital pipeline for the structured analysis of film scripts. More specifically, the strength and uniqueness of the proposed approach in comparison to conventional approaches lies in its seamless integration of structured data processing, subjective reader responses, and intelligent (i.e., Artificial Intelligence (AI)-driven) interpretation. For instance, the structured data processing includes a script segmentation engine that transforms unstructured creative content, including the script, into structured data formats. Further, an end-to-end feedback loop combining outreach, interaction, feedback, and analysis in a single data environment and the ability to cross-reference objective script structure with subjective emotional data, revealing key insights of the script, makes the proposed approach technically efficient. Furthermore, the demographic-aware AI filtering and feedback synthesis enable powerful comparative storytelling metrics. Moreover, the modular design using low-code and custom Application Programming Interface (API) middleware makes the proposed approach cost-efficient and scalable. To that end, the proposed approach is built to automate, optimize, and scale the qualitative review process of creative written content, making it suitable for use by production companies, screenwriters, feedback-focused script development platforms, and other similar platforms or organizations.

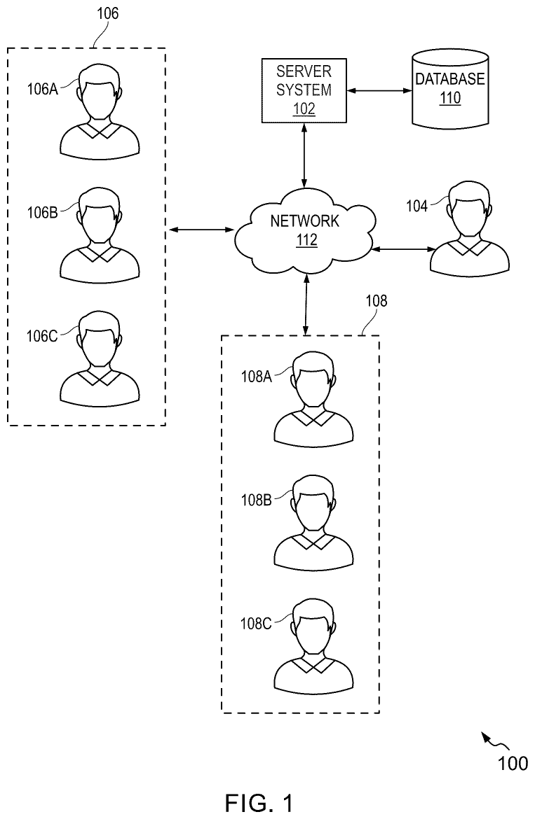

Various example embodiments of the present disclosure are described hereinafter with reference to FIGS. 1 to 10.

FIG. 1 illustrates an example representation of an environment 100 related to at least some example embodiments of the present disclosure. Although the environment 100 is presented in one arrangement, other embodiments may include the parts of the environment 100 (or other parts) arranged otherwise, depending on, for example, determining the quality of media content. Various examples of the media content can include any data, text, sounds, images, graphics, music, photographs, or advertisements, including video, films, Television (TV) series, streaming content, webcasts, podcasts, blogs, online forums, chat rooms, filmed entertainment, and the like. The term ‘quality’ refers to a degree of excellence in something. In the context of reviewing the media content, the term ‘quality’ refers to the degree of excellence of the media content by checking whether it can connect with its audience (or content viewers) or not.

The example representation of the environment 100 as depicted in FIG. 1 includes a plurality of entities, such as a server system 102, a first user 104, a plurality of second users 106A, 106B, and 106C (collectively, referred to as second users 106), a plurality of third users 108A, 108B, and 108C (collectively, referred to as third users 108), and a database 110, each coupled to, and in communication with (and/or with access to) a network 112.

As described earlier, for determining the quality of the media content prior to a general release of the media content to the public or the content viewers, conventionally, a test screening is performed. However, test screening may necessitate re-edits and re-shoots of the media content if test screening results demand so, which is quite expensive. Also, other conventional approaches lack audience-level and data-driven analysis, thereby failing to accurately predict whether the audience will connect with the script of the media content or not. Therefore, there is a need for a technical solution including methods and systems for determining the quality of the media content, which is real-time and efficient in terms of time and financial expenses.

The above-mentioned technical problems, among other problems, are addressed by one or more embodiments implemented by the server system 102, and the methods thereof provided in the present disclosure. Thus, it may be understood that the server system 102 is configured to perform one or more operations such that the quality of the media content is determined with minimal expenses. Also, the server system 102 aims to generate real-time predictions about audience opinions on the media content at the early stages of the making of the media content. The one or more operations may be explained further in various embodiments of the present disclosure.

As may be understood, the process of generating the media content involves a number of complex and discrete stages, beginning with an initial story, idea, or commission. Production of the media content, then continues through screenwriting (i.e., script preparation), casting, pre-production, shooting, sound recording, post-production, and test screening of the finished product before an audience, which may result in a media content release and exhibition. The process is nonlinear, as a content creator typically records the script (otherwise also referred to as ‘screenplay’) out of sequence, repeats shots as needed, and puts them together through editing later. It is to be noted that the making of the media content occurs in a variety of economic, social, and political contexts around the world, and uses a variety of technologies and cinematic techniques to make the media content. For instance, the media content can include theatrical films, episodic films for television and streaming platforms, short films, music videos, promotional and educational films, and the like. In recent times, the media content has been released in digital form for distribution and broadcast.

Thus, it may be understood that the test screening is performed on the already recorded media content. Therefore, to reduce the cost involved in determining the quality of the media content, the quality can be checked at the stage when the screenplay is ready. In one embodiment, the server system 102 is configured to determine the quality of the media content by performing the one or more operations on the screenplay.

In a non-limiting implementation, the first user 104 can be a content creator, content manager, content director, content owner, or the like. It is to be noted that the first user 104 can be associated with a team of individuals involved in performing various operations that are required to prepare and produce the complete media content. For instance, the team can include, but is not limited to, a screenwriter, director, producer, studio, financier, a storyboard artist, a media content producer, a production designer, a director of photography, a sound designer, a composer, and the like. In some embodiments, the first user 104 can be a leader of the team, taking complete responsibility for successfully completing the shooting or recording of the media content and making it possible for it to reach or connect with the targeted audience. In some other embodiments, the first user 104 can be an Intellectual Property (IP) owner, licensor, manager of the owner's creative assets, and the like.

In some embodiments, the first user 104 may hire the second users 106 to determine the quality of the media content. In one embodiment, the second users 106 may be selected from a population of individuals. It is noted that the second users 106 may read textual data associated with the screenplay and provide their feedback in different ways. The second users 106 may be exclusively hired to receive their feedback only. It is noted that the second users 106 are obliged not to disclose details of the media content under review to the public. This may be performed to predict end-users' responses prior to the release of the media content. For example, the second users 106 can include content readers, professional readers, non-professional readers, and other common people who can read and understand the text. In an embodiment, the second users 106 can be provided with a payment for providing feedback after reading the screenplay.

In some embodiments, several latest technologies, such as Artificial Intelligence (AI) or Machine Learning (ML), and Deep Learning (DL) concepts may be adopted to determine the quality of the media content. Thus, it may be understood that the server system 102 may be configured to train one or more AI or ML models to determine the quality of the media content based at least on analysis of the textual data related to the screenplay and/or a storyline corresponding to the preparation of the media content.

In an embodiment, the server system 102 is configured to extract the textual data related to the screenplay associated with the media content being produced by the first user 104. Herein, the screenplay is to be reviewed by a plurality of second users such as the second users 106. Further, the server system 102 is configured to segment the textual data into a plurality of sections (hereinafter otherwise, also referred to as ‘sections’, a ‘plurality of pages’, and ‘pages’). Herein, each section of the plurality of sections is displayed to the plurality of second users 106. Thereafter, the server system 102 may be configured to receive one or more user inputs from each of the second users 106 for each respective section of the plurality of sections. In an embodiment, the textual data and the user inputs may be stored in the database 110 as input data that is processed by the server system 102.

In various non-limiting examples, the database 110 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a Redundant Array of Independent Disks (RAID) controller, a Storage Area Network (SAN) adapter, a network adapter, and/or any component providing the server system 102 with access to the database 110. In one implementation, the database 110 may be viewed, accessed, amended, updated, and/or deleted by an administrator (not shown) associated with the server system 102 through a database management system (DBMS) or relational database management system (RDBMS) present within the database 110.

In some embodiments, the second users 106 may use any type of electronic devices (not shown in FIG. 1) for providing their inputs. For example, the electronic devices may include, but are not limited to, a desktop computer, a smartphone, a tablet computer, a mobile phone, a laptop computer, a personal digital assistant, a web-enabled wearable device, a large display unit, a set of display units, or the like. Similarly, in a non-limiting implementation, the first user 104 may also use any of the electronic devices mentioned above for recording, editing, producing, and the like, the media content. In some embodiments, any of the electronic devices mentioned above can be used for performing any operations involved in the production of the media content. The process of accessing the textual data and receiving the user inputs, examples of different user inputs, and the like are explained in detail later with reference to different figures described in the present disclosure.

In one embodiment of the present disclosure, the database 110 is utilized by, but is not limited to, the electronic devices and the server system 102 via the network 112. In another embodiment, the database 110 may be incorporated into the server system 102. In yet another embodiment, the database 110 may be an individual entity connected to the server system 102 or maybe a database stored in cloud storage. The network 112 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 112 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 112 may utilize a secure protocol (e.g., Hypertext Transfer Protocol (HTTP), Secure Socket Lock (SSL), and/or any other protocol), or a set of protocols for communicating with the various entities depicted in FIG. 1.

Further, in one embodiment, the server system 102 is configured to determine user behavior corresponding to each second user of the plurality of second users 106 and a set of interpretations related to the screenplay based, at least on analysis of the textual data and the one or more user inputs. Herein, the user behavior may include levels of user attachment to the storyline and each character of the screenplay, insights into user responses from the user inputs, etc. Further, the set of interpretations can include an idea metric, a character appeal metric, a character dialogue metric, an originality metric, an emotional impact metric, a clarity metric, a suspense metric, and the like. In an embodiment, for determining these interpretations, the server system 102 is configured to determine a set of character-related interpretations, a character appeal of each character, a set of statistical parameters, and the like. In a specific embodiment, the set of character-related interpretations may include a speaking frequency of one or more characters in the screenplay, a mention frequency of the one or more characters, a correlation between the one or more user inputs and the presence of the one or more characters, a centrality of each character, a character importance of each character, a main character, a character network interpretation, etc. Herein, in some embodiments, the determination of the user behavior may be dependent on the determination of the set of interpretations and vice versa. In some other embodiments, the determination of components of the user behavior may be interdependent. Similarly, the determination of components of the set of interpretations may be interdependent.

In a non-limiting implementation, the server system 102 may determine the user behavior and the set of interpretations using one or more ML models associated with the server system 102. It is to be noted that the ML models may also be stored in the database 110. Finally, a prediction indicative of a predicted quality of the media content may be generated from the textual data based at least on the user behavior and the set of interpretations. In an embodiment, the prediction may be generated by the one or more ML models. The process of determining the user behavior and the set of interpretations and generating the prediction is explained in detail later with reference to different figures in the present disclosure.

As may be understood, the predicted quality of the media content may provide insights into an expected response from content viewers who will be viewing the media content after it is released to the public. The term ‘third users’ is used in the present disclosure to indicate the content viewers. In other words, the predicted quality of the media content provides one or more insights on an expected response from one or more third users (e.g., the third users 108) who view the media content after a public release of the media content. In an embodiment, the third users 108 may include end users or consumers of the media content, audience, content viewers, and the like. Herein, the third users 108 may also utilize any type of the above-mentioned electronic devices for viewing the media content.

In an embodiment, the server system 102 is deployed as a standalone application, a client/server, a website, or can be implemented in the cloud as Software as a Service (SaaS). In a non-limiting implementation, the server system 102 provides or hosts a website with a first User Interface (UI) in an electronic device used by the first user 104. Herein, the first UI may correspond to a UI that facilitates the first user 104 to control operations facilitated by the server system 102. In other words, the first user 104 can be a managing entity, an administrator, or an admin of the server system 102. In some embodiments, the first UI may provide features, such as publishing the textual data of the script to electronic devices of the second users 106, receiving the user inputs provided as feedback by the second users 106, controlling various configurations of the server system 102, controlling various verticals displayed on the electronic devices of the second users 106, and the like.

Similarly, in another non-limiting implementation, the server system 102 provides or hosts a website with a second UI in the electronic devices used by the second users 106. Herein, the second UI may correspond to a UI that facilitates the second users 106 to read the textual data, provide their feedback, perform one or more interactions with the textual data, and the like. In some embodiments, the second UI also provides the second users 106 with a demographic questionnaire. The second users 106 may have to fill it out while applying to be a reader of the screenplay, so that the first user 104 is willing to be read and reviewed for its quality. Once any of the second users 106 are selected, such as the second user 106A, the first user 104 may send a link of a particular screenplay to the electronic device of the second user 106(1). The second UI may display the received screenplay to the second user 106(1) when the second user 106(1) clicks on the received link. It is to be noted that the screenplay (or script) is shared only with people selected for reading and reviewing the script and limits access to anybody other than the selected people.

In some embodiments, the server system 102 utilizes a third-party platform such as a third-party cloud-based platform, for creating and sharing relational databases between different users, such as the first user 104 and the second users 106. The third-party platform may facilitate user-friendly interfaces, allowing the users such as the first user 104 and the second users 106 to store, organize, manage, and collaborate on information in a flexible way. For instance, the third-party platform integrated into the server system 102 supports user management, script metadata tracking, email campaign logging, feedback analysis, and the like.

In a specific embodiment, the third-party platform can serve as a central operating system of the server system 102. In an embodiment, the database 110 of the server system 102 may be managed by the third-party platform. Thus, it is noted that the server system 102 is configured to store information, such as but not limited to the reader's profile, script metadata, reader feedback, mail tracking, engagement logs, analysis dashboards, and the like. In a non-limiting implementation, the reader's profile can include demographic and behavioral data. In another implementation, the script metadata can include information about each script, its title, author, length, genre, etc. In yet another implementation, the reader feedback can include structured forms for reviews, line-by-line commentary, character ratings, and the like. Further, in an example implementation, the mail tracking can include status logs for outreach campaigns. Further, the engagement logs can include records of reading behavior, imported via APIs. The analysis dashboards can include custom views for data filtering, aggregation, export, and the like. In an embodiment, the third-party platform may provide a no-code UI such as the first UI to operational users such as the first user 104 to manage the workflow of the server system 102. For instance, the third-party platform makes it easy to display script entries, sort and filter by status, and take actions. In an example scenario, the actions can include marking a user as active/inactive, launching scripts, sending emails, or the like.

In some other embodiments, the server system 102 is configured with one or more Application programming interfaces (APIs) that enable seamless programmatic interactions between the third-party platform, external applications such as the applications or platforms on the electronic devices of the first user 104 and the second users 106, especially for pushing and pulling script assignments, user statuses (such as factors (e.g., which pages were read and for how long) associated with the user behavior), reading metrics (such as the set of character-based interpretations including emotional reactions, text-based reviews, numeric ratings, etc.), pulling a list of the second users 106 from the database 110, pushing assignments of the readers to specific screenplays, and the like. It is noted that the usage of the third-party platform and the APIs facilitates the server system 102 for the automation of tasks that would otherwise be manually intensive and ensures that all reader activities are traceable, time-tamped, and available for analysis.

It is to be noted that the server system 102 is a separate part of the environment 100 and may operate apart from (but still in communication with, for example, via the network 112) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. More specifically, it should be noted that the number of electronic devices, server system, and databases described herein are only used for exemplary purposes and do not limit the scope of the invention. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 112, which may be specifically configured, via executable instructions, to perform steps as described herein, and/or embodied in at least one non-transitory computer-readable media.

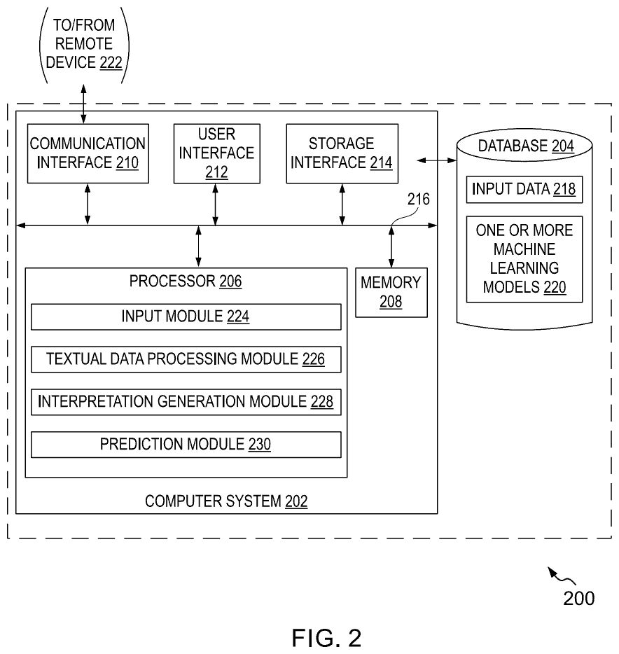

FIG. 2 illustrates a simplified block diagram of a server system 200, in accordance with an embodiment of the present disclosure. For example, the server system 200 is similar to the server system 102 as described in FIG. 1. In an embodiment, the server system 200 is configured to facilitate the interpretation and optimization of digital designs for generating a deployable client-side code corresponding to an application or a website. In some embodiments, the server system 200 is embodied as a standalone physical server and/or has a cloud-based and/or SaaS-based (software as a service) architecture.

The server system 200 includes a computer system 202 and a database 204. The computer system 202 includes at least one processor such as a processor 206, for executing instructions, a memory 208, a communication interface 210, a user interface 212, and a storage interface 214. The one or more components of the computer system 202 communicate with each other via a bus 216. The components of the server system 200 provided herein may not be exhaustive, and the server system 200 may include more or fewer components than those depicted in FIG. 2. Further, two or more components depicted in FIG. 2 may be embodied in one single component, and/or one component may be configured using multiple sub-components to achieve the desired functionalities. The database 204 is an example of the database 110 of FIG. 1.

In some embodiments, the database 204 is integrated into the computer system 202. For example, the computer system 202 may include one or more hard disk drives as the database 204. In one non-limiting example, the database 204 is configured to store input data 218, one or more ML models 220, and the like. In an embodiment, the input data 218 includes a screenplay corresponding to a storyline for which the media content is to be recorded by the first user 104. In another embodiment, the input data 218 also includes one or more user inputs that may be received from the second users 106 as they read the screenplay. Examples of the user inputs include, but are not limited to, free-form comments, selection of various options (e.g., abandon, lagging, neutral, interested, eager, etc.), pausing behavior, survey inputs taken after the last page is reached, reason inputs for pausing, etc.

The user interface 212 is an interface, such as a Human Machine Interface (HMI) or a software application (standalone application, Integrated Development Environment (IDE) extension (e.g., Visual Studio Code extension), Figma© plugin, etc.), that allows users such as an administrator to interact with and control the server system 200 or one or more metrics associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a Redundant Array of Independent Disks (RAID) controller, a Storage Area Network (SAN) adapter, a network adapter, and/or any component providing the processor 206 with access to the database 204.

It is to be noted that although the computer system 202 is depicted to include only one processor such as the processor 206, the computer system 202 may include a greater number of processors therein. The processor 206 includes a suitable logic, circuitry, and/or interfaces to execute computer-readable instructions for performing one or more operations for determining the quality of the media content. Examples of the processor 206 include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), and the like.

In one embodiment, the memory 208 is capable of storing computer-readable instructions. Examples of the memory 208 include Random-Access Memory (RAM), Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the computer system 202 can communicate with a remote device 222, such as any entity connected to the network 112 (as shown in FIG. 1).

It is to be noted that the server system 200 as illustrated and hereinafter described, is merely illustrative of an apparatus that could benefit from embodiments of the present disclosure and, therefore, should not be taken to limit the scope of the present disclosure. It is noted that the server system 200 may include fewer or more components than those depicted in FIG. 2.

The processor 206 is depicted to include an input module 224, a textual data processing module 226, an interpretation generation module 228, and a prediction module 230. Herein, the input module 224, the textual data processing module 226, the interpretation generation module 228, and the prediction module 230 are communicatively coupled with each other. It should be noted that components described herein can be configured in a variety of ways, including electronic circuitry, digital arithmetic, logic blocks, and memory systems in combination with software, firmware, and embedded technologies.

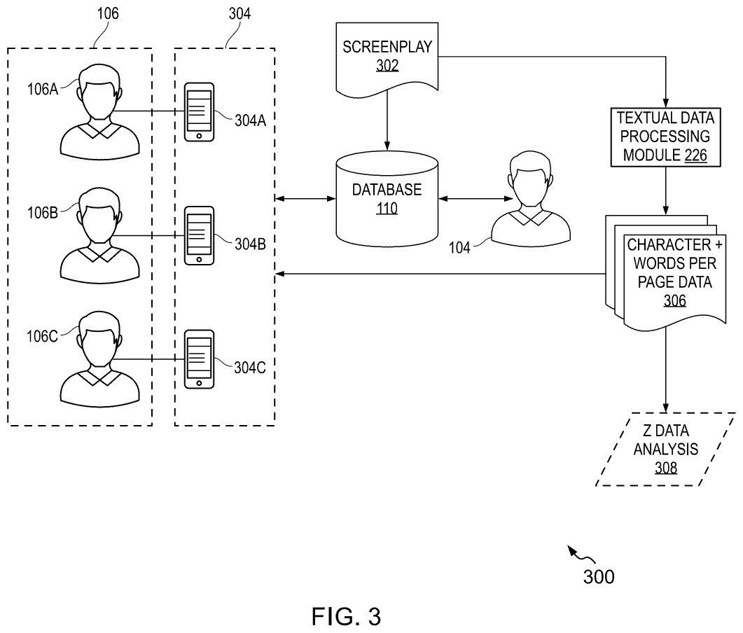

As may be understood, the objective of the server system 200 is to determine the quality of the media content by receiving the user inputs from the second users 106 for a screenplay such as the screenplay (see, 302 of FIG. 3) of the media content. Herein, the user inputs correspond to subjective and objective measures of the second users 106. The server system 200 receives these user inputs and converts them into structured data, from which the quality of the media content can be predicted. Further, a predicted audience response, i.e., the response of the third users 108 can be predicted based on the predicted quality of the media content.

In an embodiment, the input module 224 may include suitable logic and/or interfaces for extracting the textual data related to the screenplay associated with the media content being produced by the first user 104. In an embodiment, the textual data may be accessed from the database 204. As may be understood, the screenplay or files related to the screenplay of the media content are stored in the database 204. Thus, the textual data related to the screenplay is extracted by the input module 224 to prepare it in a preferred format. The textual data is thus provided to the textual data processing module 226 for further processing. It is to be noted that the textual data in the preferred format is then transmitted to the second users 106 on their electronic devices for them to read and provide their responses.

In another embodiment, the input module 224 is further configured to receive the user inputs corresponding to each section of the textual data from each of the second users 106 reading the textual data. The preferred format in which the textual data is converted may have divided the textual data into a plurality of sections. In other words, the textual data processing module 226 may segment the textual data into the plurality of sections to display the textual data section-by-section to the plurality of second users 106. In other words, each section of the plurality of sections is displayed to the second users 106. For instance, the screenplay is displayed to the second users 106 one section at a time. In one embodiment, each section corresponds to each page. Thus, the second users 106 may have read the textual data, section by section, and provided their inputs for a particular section prior to moving to a subsequent section of the textual data. Further, upon receiving the user inputs, the input module 224 may be configured to store the user inputs in the database 204.

In one embodiment, the textual data processing module 226 may include suitable logic and/or interfaces for generating a plurality of features associated with the textual data based, at least on the textual data and processing criteria. In a non-limiting implementation, the processing criteria include performing a parsing operation on the textual data. In one embodiment, one of the features is to convert the textual data into the preferred format. As mentioned earlier, the preferred format corresponds to discrete units or sections and displays one unit at a time to the second users 106 on their electronic devices such as the electronic devices 304 (as shown in FIG. 3).

In a non-limiting implementation, the textual data may be provided to the textual data processing module 226 in a predefined format such as, but not limited to, a Portable Document Format (PDF). In another embodiment, some other features of the features include extracting information about the screenplay, such as character names, total word counts, words per section, and number of appearances or speeches by each character for the purpose of identifying the main characters in the screenplay, and the like. It is to be noted that all these features may be provided to the interpretation generation module 228 for further processing.

In an embodiment, the interpretation generation module 228 may include suitable logic and/or interfaces for determining user behavior corresponding to each second user of the plurality of second users 106 and the set of interpretations related to the screenplay based, at least on analysis of the textual data and the user inputs. More specifically, the interpretation generation module 228 may determine the user behavior and the set of interpretations based, at least in part, on the features.

The textual data obtained from the textual data processing module 226 has standard formatting such as the preferred format, that facilitates determining the user behavior and the set of interpretations. In one embodiment, the user behavior and the set of interpretations can be determined based, at least on the preferred format of the textual data and the generated features.

As mentioned earlier in the present disclosure, the set of interpretations can include an idea metric, a character appeal metric, a character dialogue metric, an originality metric, an emotional impact metric, a clarity metric, a suspense metric, and the like. Further, in an embodiment, for determining the set of interpretations, the interpretation generation module 228 is configured to determine a set of character-related interpretations, a character appeal of each character, a set of statistical parameters, and the like. It is noted that while determining the character-related interpretations, the character appeal, and the statistical parameters, the interpretations such as the idea of the screenplay, the character appeal of various characters in the screenplay, the impact of character dialogue, the originality of the screenplay, the emotional impact, clarity, and suspense fullness of the screenplay may be determined. These interpretations may be further beneficial for generating accurate predictions for the quality of the media content that may be recorded based on the screenplay.

In a specific embodiment, the set of character-related interpretations may further include, but not limited to, a speaking frequency, a mention frequency, a correlation between the user inputs and the presence of the characters in a particular section of the screenplay, the character importance of each character, a centrality of each character, a character network interpretation, a main character determination, etc. The interpretation generation module 228 may be configured to determine a speaking frequency of one or more characters in each section of the screenplay based, at least on the textual data and the features. Herein, the term ‘speaking frequency’ refers to a number of times the one or more characters have spoken in the screenplay. The interpretation generation module 228 is also configured to determine a mention frequency of the one or more characters in the screenplay and in one or more descriptive parts of the screenplay based, at least on the textual data and the features. Herein, the term ‘mention frequency’ refers to a number of times the one or more characters are mentioned in the screenplay.

In another embodiment, the interpretation generation module 228 is further configured to determine a correlation between the user inputs and the presence of the one or more characters in each section of the screenplay based, at least on the features. Further, in yet another embodiment, the interpretation generation module 228 is configured to determine a centrality of the one or more characters in the screenplay based, at least on the speaking frequency, the mention frequency, and the correlation between the user inputs and the one or more characters. Herein, in an embodiment, determining the centrality of the characters leads to performing character network analysis.

In another embodiment, the character network analysis is performed to determine the character network interpretation. As used herein, the term “character network analysis” refers to the analysis of a character network for understanding various character network interpretations, such as the roles of each character, the relationship between the characters, and interactions between the characters in a screenplay. In an example implementation, the character network can be represented in the form of a graph with each node representing an individual character of the screenplay and each edge representing a relationship or an interaction between two characters connected by the corresponding edge.

Upon determining the centrality of the characters, the interpretation generation module 228 can determine the character importance of each character in the screenplay based on the centrality and a centrality threshold. Further, the interpretation generation module 228 may identify a main character from the one or more characters of the screenplay based on the character importance of the one or more characters. Thus, it may be understood that all the characters having the centrality at least equal to the centrality threshold may have higher character importance and can be classified as the main characters, and the rest of the characters can be classified as side characters. It is to be noted that the main characters will usually appear more frequently and will always be more central in the character network analysis, touching the greatest number of other characters. It is crucial that the main characters in the screenplay are determined because the reader's (i.e., the second users 106) attachment to them is the main determinant of the success of the screenplay after the preparation of the media content. As a result, the user behavior of the readers such as the second users 106 may be determined.

In an embodiment, the interpretation generation module 228 is configured to generate the character network based, at least in part, on the plurality of features and the one or more characters in the screenplay. As described earlier, the character network is indicative of a graph including a plurality of nodes and a plurality of edges. Herein, at least one edge of the plurality of edges connects one or more node pairs of the plurality of nodes. Each node may indicate each character, and each edge may indicate an interaction between two nodes connected by the corresponding edge.

Further, the interpretation generation module 228 may categorize the one or more interactions between the one or more characters based at least on an assignment of an interaction type label to each edge in the character network. Thereafter, the interpretation generation module 228 may generate a relationship prediction for the character network interpretation for each character based at least on the categorization of the one or more interactions. The relationship prediction may indicate a relationship of each character with every other character of the one or more characters. In a non-limiting implementation, the interpretation generation module 228 may perform these operations using the one or more ML models 220.

In a non-limiting implementation, the character network analysis may also be performed using the ML models 220. One example of the ML models 220 can be a transformer model. In one embodiment, the transformer model can be trained to identify whether characters are addressing each other by providing a binary indication of interaction. In another embodiment, the transformer model can be trained to categorize interactions using the binary indications, such as friendly, hostile, romantic, etc. It is to be noted that such categorical edge labels (i.e., the binary indications) allow modeling different interaction types through multiplex networks, i.e., data structures that quantify multiple relationship layers. Similarly, in yet another embodiment, higher-order networks can extend beyond pairwise character interactions to encode group dynamics involving three or more characters, which often cannot be reduced to pairwise sums.

Moreover, another example of the ML models 220 can be temporal networks. In one embodiment, the temporal networks can capture how character relationships evolve over time by modeling dynamic interactions. Techniques such as process motifs can discover repeated patterns, facilitating the quantification of narrative elements, such as love triangles or new friendships/rivalries forming. The character network analysis using character network visualizations can also aid in story analysis. Furthermore, combining process motifs with engagement data could determine if subplots like love triangles boost or diminish audience ratings.

In addition, the character network analysis provides a powerful, quantitative lens to model narrative character dynamics in ways that could significantly enrich audience understanding and story development. By extracting computable features from the rich relational data in character networks, the server system 200 can unlock deeper insights into what story elements resonate most strongly with the audience, i.e., the third users 108.

In some embodiments, the interpretation generation module 228 is also configured to determine the character appeal of each character in each section and the set of statistical parameters for the screenplay. In a non-limiting implementation, the character appeal and the set of statistical parameters are determined using the ML models 220. The process of determining the character appeal and the statistical parameters is explained later in the present disclosure.

Further, as may be understood, the free-form comments on each page are one of the user inputs. In an embodiment, the interpretation generation module 228 is configured to determine a summary of the free-form comments using the ML models 220. This summary also has an impact on the user behavior determined earlier. In some other embodiments, the interpretation generation module 228 is also configured to analyze clusters of comments that can be significant in themselves. Further, the interpretation generation module 228 is configured to determine the user behavior and the set of interpretations based at least on analysis of the survey received from the second users 106 upon reaching the last page (or last section) of the screenplay and reading it completely. It is to be noted that the survey also includes the names of the characters that are present in the screenplay.

It is to be noted that the interpretation generation module 228 is configured to separate the comments according to what page (or section) the comment pertains to, as well as the global script comments, the readers, i.e., the second users 106 may leave. Thus, it may be understood that the user behavior, the set of interpretations, and the other elements that have been determined so far can be considered to be various interpretations associated with the textual data and the user inputs.

As described earlier, the second users 106 also have the multiple options on every page (or section) in the form of buttons displayed on the second UI on the electronic devices 304 of the second users 106. In a non-limiting implementation, the buttons may be positioned at the bottom of the page (or section). In one embodiment, one of the multiple options includes an option to ‘Abandon’ the reading, in which case they are taken directly to the end survey. Selecting the option ‘Abandon’ indicates that the second users 106 is not willing to finish reading the complete story and stops in-between. Failure to finish reading is referred to as a drop-off, the determination of which is itself a significant data point. Further, it provides a failure analysis, which is explained in detail further in the present disclosure with reference to various figures.

Further, these button choices at the bottom of each page provide no indication of why a reader, i.e., any of the second users 106 had made those selections. However, if hundreds of readers show a decline in interest in a storyline poses the why question in specific ways. It is to be noted that the possible answers to that question can come from the freeform comments and the extensive survey readers take at the end of the reading.

Thus, in order to understand the reason behind the selections made by the second users 106, the interpretation generation module 228 may generate another interpretation such as a momentum line, that alerts problem areas in the screenplay. The process of generating this interpretation is explained in detail further in the present disclosure.

In some embodiments, the ML models 220 may be used for analyzing the comments, based on which the sentiments of the second users 106 in the relevant pages can be determined. In some other embodiments, various statistical analysis techniques may be used for analyzing the comments. In a specific embodiment, the interpretation generation module 228 is configured to check for a set of queries while analyzing the comments. In an embodiment, the set of queries is as follows:
(i) Are people pausing more than randomly in these same areas?
(ii) How do pausers feel about resuming their reading?
(iii) What characters are on the pages that lag? Or generate Eager scores? Reader engagement with specific characters has a major effect on overall story engagement.
(iv) Are there other issues flagged in the end survey, such as a lack of clarity, that may be interfering with engagement in these sections?, and the like.

It is to be noted that the interpretation generation module 228 may query the database to determine pauses and pause patterns. Further, the interpretation generation module 228 may query a popup that asks the reason for a reader's pausing (set with a configurable timer such as for about 3 minutes with no activity), and a popup that queries how the reader (e.g., the second users 106) feels about resuming reading.

Further, in a non-limiting example, the statistical analysis techniques can include the Analysis of Variance (ANOVA) test. It is to be noted that an ANOVA test, tests if two distributions are significantly different by comparing them to the null hypothesis that they are drawn from the same distribution. Demographic categories with significant discrepancies in the distribution may be identified. For example, the distributions broken down by the factor ‘gender identity’ may be identified to have significantly different distributions for the factor ‘overall rating’. Further, a t-test may be used to determine which values of the ‘gender identity’, such as men or women, display a difference from a sample mean. If a significant difference is detected for one of these values, a sentence is added here.

In a non-limiting implementation, the following are detailed steps performed by the server system 200 when the statistical analysis techniques are employed for analyzing the comments using the above-mentioned set of queries:
1. The ANOVA test checks if the distributions of a specific variable, such as ‘overall rating’, are significantly different across various demographic categories (such as ‘gender identity’). The null hypothesis for an ANOVA test is that all groups are drawn from populations with the same mean, i.e., implying that any observed differences in sample means are due to random chance.
2. Identifying Significant Discrepancies: By applying ANOVA to data broken down by demographic categories, whether the different groups (e.g., different genders) show statistically significant variations in their overall rating can be identified. For example, the mean ratings provided by men and women are significantly different.
3. Follow-up with t-tests: Once ANOVA indicates significant differences, you can use t-tests to analyze these differences more deeply between individual groups. A t-test compares the means between two groups to determine if they are statistically different from each other.
4. Application: If ANOVA shows that there are differences in overall rating by gender identity, a t-test between the ratings given by men can be performed, and another by women compared to the overall sample mean. This helps identify which specific group's mean rating significantly deviates from the overall mean.
5. Reporting Results: If a significant difference is detected in the t-tests for any group (such as men or women), this information is summarized and presented. For example, it might be stated that—“Individuals in the male category of ‘gender identity’ rate the variable ‘execution rating’ 19.11% higher than the population mean”.

It is to be noted that these insights may be derived using a Linear Regression Analysis. Linear regression is a statistical method used to model the relationship between a dependent variable and one or more independent variables by fitting a linear equation to observed data. For example, how salary depends on variables like years of experience and education level can be modeled. The following are detailed steps performed by the server system 102 for the implementation of the linear regression used for analyzing the comments:
1. The primary goal of linear regression is to predict the value of a dependent variable based on the values of one or more independent variables. It establishes the equation that best predicts the dependent variable from the independent variables. For instance, predicting employee performance based on training hours and job satisfaction.
2. Model Fitting: Linear regression involves finding the line of best fit through the data. This line is represented by the regression equation:

$$\$ Y = ∖ beta\_ 0 = ∖ beta\_ 1 X\_ 1 + ∖ beta\_ 2 X\_ 2 + ∖ hdots + ∖ beta\_nX \_n + ∖ epsilon \$ \qquad Eqn . ( 1 )$$

Herein, ‘Y’ is the dependent variable, ‘β₀’ is the intercept, ‘β₁, β₂, . . . , βₙ’ are the coefficients of the independent variables ‘X₁, X₂, . . . , Xₙ’, respectively, and ‘ε’ is the error term.
3. Coefficient Interpretation: The coefficients (e.g., β₁, β₂) indicate the magnitude and direction of the relationship between each independent variable and the dependent variable. For example, β₁ represents the change in salary for a one-unit increase in years of experience, holding other variables constant.
4. Statistical Significance and Fit: The significance of the regression coefficients is tested using t-tests, and the overall fit of the model is usually assessed using R-squared, which measures the proportion of variance in the dependent variable that is predictable from the independent variables.
5. Reporting Results: If a coefficient, such as β₁, is found to be significantly different from zero, this suggests that the corresponding independent variable (e.g., years of experience) has a statistically significant impact on the dependent variable (salary). Results are typically summarized with statistics like the R-squared value, F-statistic, and p-values for each coefficient.

In some other embodiments, the interpretation generation module 228 may also be configured to generate summaries of the interpretations along with graphical representations (explained later in the present disclosure with reference to different figures). The interpretation generation module 228 may be configured to determine the level of certainty for the various categories and display the ones with a high P-value in sentence form. As used herein, the term ‘P-value’ refers to a probability value that is a number that indicates how likely a value that is at least equal to the actual observation can be obtained if the null hypothesis is correct. Basically, it is a statistical measurement used to validate a hypothesis against observed data. Herein, the term ‘null hypothesis’ refers to a type of statistical hypothesis that proposes that no statistical significance exists in a set of given observations.

In one embodiment, the different categories of the interpretations can include emotional impact, ending rating, humor rating, middle rating, overall reaction, and the like. In a non-limiting example, the summaries of the interpretations made for these categories may be as follows:
(i) Individuals in the $25 k-439,999 of household income, rate the emotional impact as 41.18% higher;
(ii) Individuals with a gender identity being ‘male’, rate the ending rating as 29.93% lower;
(iii) Individuals with the gender identity being ‘other’, rate the ending rating as 43.07% higher;
(iv) Individuals with the education level of ‘some college’ rate the humor rating as 60.13% higher; and the like.

Further, in a non-limiting implementation, different interpretations generated by the interpretation generation module 228 include but are not limited to drop-off rate by age and gender, momentum, pausing, momentum plus pausing, character networks, and the like. As used herein, the term ‘momentum’ refers to readers' desire to turn the page and keep reading, from which a page-by-page graph reflecting a reader's engagement can be generated. Further, the term ‘drop-off’ refers to an attrition in which readers cease to read before the script ends. Similarly, the term ‘character network’ refers to a map corresponding to the appearance of characters in the story, which can correlate with momentum and drop-off, as well as the comments from the readers. All these interpretations are explained in detail later in the present disclosure with reference to various figures.

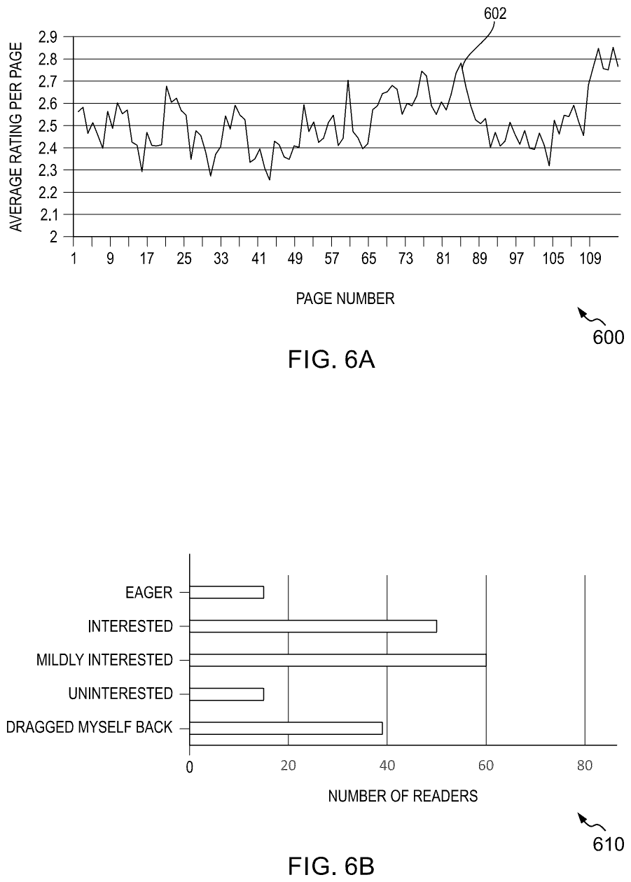

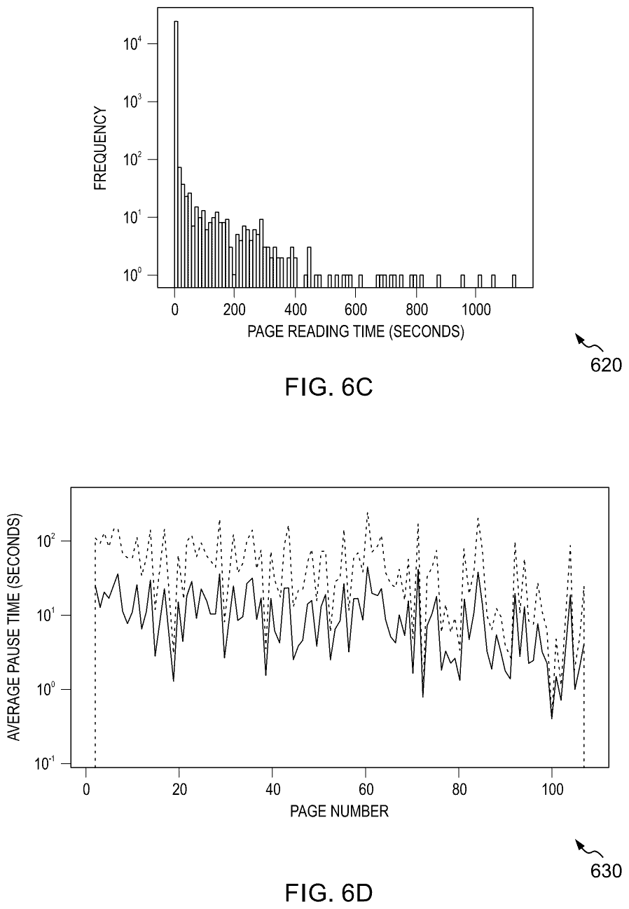

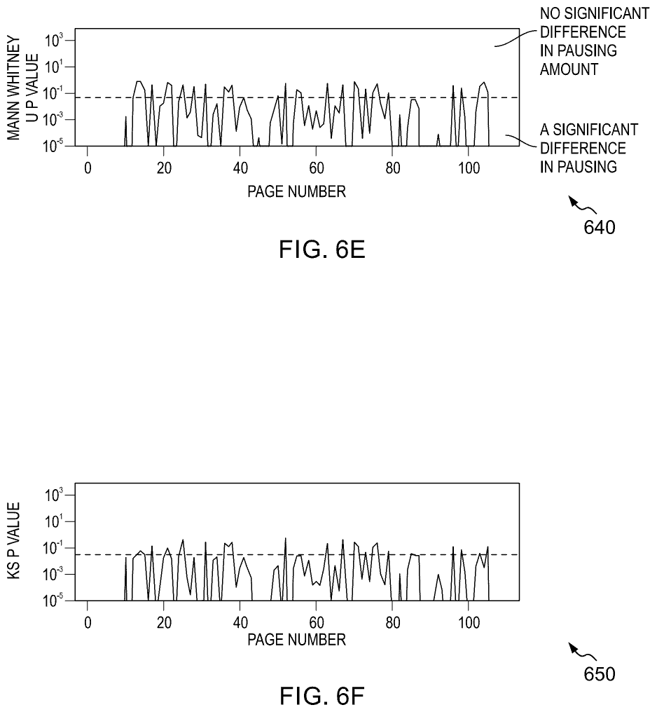

Among all the interpretations, one important interpretation is the analysis of pauses, i.e., specific moments when readers stop reading. A pause is defined as any significant break taken by a reader (e.g., the second user 106A) between sections or pages. Detecting these pauses and determining when the number of pauses on a page is unexpectedly high is a challenging task. This analysis focuses primarily on identifying significant clustering of pauses that deviate from expected patterns (as shown in FIG. 6C).

To analyze the pauses, the interpretation generation module 228 is configured to initially consider each pause as a data point associated with timestamps indicating when the second user 106A starts a new page, as shown in FIG. 6D. Thus, the interpretation generation module 228 can calculate reading time taken per page for each reader such as the second users 106 based at least on the timestamps associated with a pause as shown in FIG. 6C.

In one embodiment, the interpretation generation module 228 may be configured to analyze the pauses using a simple ML model to serve as a baseline. According to this analysis, pauses are considered independent and uncorrelated events across the script. Under this model, the interpretation generation module 228 treats the decision to pause as analogous to flipping a weighted coin, which is a stochastic process where the probability of pausing is constant and does not depend on the script's content or the reader's previous behavior. This process is described as time-homogeneous, implying that the likelihood of pausing is consistent throughout the reading session, and Markovian, meaning it lacks memory of past events (each decision to pause is independent of previous decisions).

In an embodiment, the model can be trained using a Poisson distribution, commonly used to model the number of failures expected in a given unit of time. Herein, the term “failure” could be interpreted as deciding to pause after a streak of non-pause page turns. The interpretation generation module 228 then compares the empirical distribution of pauses per page against this theoretical distribution to identify pages with anomalously high pauses. However, this simplistic model likely falls short of capturing real-world complexities, such as time-inhomogeneity and memory effects. Herein, the term ‘time-inhomogeneity’ refers to a factor that captures the frequency of pauses that might vary depending on the progression of the story, reflecting narrative complexity or emotional intensity at different stages. Further, the term ‘memory effects’ refers to a factor that captures the historical pausing behavior of the second users 106. In other words, contrary to our initial Markovian assumption, a reader's decision to pause could be influenced by their actions on previous pages, suggesting a dependency or memory in the pausing behavior.

Thus, in order to consider these complexities, a more sophisticated model is necessary. In one embodiment, one effective approach is the Autoregressive Integrated Moving Average (ARIMA) model, which could accommodate both the seasonality (time-inhomogeneity) and memory effects observed in pause patterns. The ARIMA models the number of pauses based on previous values (autoregressive), integrates trends over time to stabilize the series (integrated), and smoothens out noise and short-term fluctuations (moving average).

To validate these models, the interpretation generation module 228 may employ techniques such as the Ljung-Box test or a Jarque-Bera test. Visualizations, such as time series plots of pauses per page and overlays of model predictions, as explained further in the present disclosure, would help illustrate fit and identify outliers effectively. This nuanced analysis of script reading pauses will provide deeper insights into reader engagement and script pacing, enabling scriptwriters to refine their work according to reader interaction patterns. By moving beyond simple models to more complex representations of data, the understanding of the reading process is enhanced, and the design of scripts may be improved to match reader behaviors. In one embodiment, all these interpretations may be provided to the prediction module 230 for further processing.

In other words, the interpretation generation module 228 may access the user inputs, including the comments, the user responses, the survey inputs, pausing actions, reason inputs for pausing, user ratings for story elements of the screenplay, and the like, for each section of the screenplay from the database 204. The interpretation generation module 228 may generate the comment summary for each section based, at least in part, on the comments for the corresponding section and the set of queries. The interpretation generation module 228 may determine a pausing pattern of each second user for each section based, at least in part, on the pausing actions and the reading time of each second user for each section in the screenplay.

Further, the interpretation generation module 228 may determine a sentiment of each second user for each section based, at least in part, on the comment summary, the user responses, the survey inputs, and the pausing pattern of the corresponding second user, the sentiment being one of positive, negative, or neutral. Thereafter, the interpretation generation module 228 may compute a story momentum for the screenplay for each second user based, at least in part, on the sentiment of each second user for each section in the screenplay, the momentum indicating an engagement of the corresponding second user with the screenplay. The interpretation generation module 228 may determine the user behavior for each second user for each section based, at least in part, on the story momentum and the pausing pattern. In a non-limiting implementation, the interpretation generation module 228 may perform these operations for determining the user behavior using the one or more ML models 220.

In a specific embodiment, the interpretation generation module 228 may determine the character appeal of each character in each section based, at least in part, on a variation in user ratings and a story momentum based at least on a presence of a particular character. In a non-limiting implementation, the interpretation generation module 228 may determine the character appeal using the one or more ML models 220.

In an embodiment, prediction module 230 may include suitable logic and/or interfaces for generating a prediction indicative of a predicted quality of the media content based, at least on the user behavior and the set of interpretations. In an embodiment, the prediction may be generated using the ML models 220. As may be understood, of all the interpretations generated so far, the most important interpretation is Momentum. Next in importance would be the objective measures of how the readers read, such as pausing, number of comments per page, and continuity of reading over time (i.e., long stretches of reading correlate with greater interest). Next comes the appearance of various characters in these measures. Finally, story clarity is a key factor, which is self-reported in the end survey.

Upon obtaining all these interpretations, a final prediction may be generated indicating how well the story connects with readers and where that connection is lost. It is to be noted that it is not a number or a prediction of the box office; instead, it is a measure of the connection between the viewers and the media content. In one embodiment, the prediction module 230 may be configured to generate the prediction by applying the concept of kinetic scoring on the ML models 220.

The concept of kinetic scoring can also be termed as a ‘Kinetics Test’, which uses Natural Language Processing (NLP) to automatically score the kinetic value of each page by counting the total sentences per page and then scoring how active each sentence is. The ratio of per-page kinetic sentences to total sentences generates a kinetic score for each page. In other words, the prediction module 230 is configured to identify a total count of sentences in each section of the screenplay and a count of active sentences in each section based, at least in part, on the textual data of the screenplay. Further, the prediction module 230 may compute the kinetic score for each section based at least on the total count of the sentences and the count of active sentences in each section.

Further, in another embodiment, the prediction module 230 may generate a plot for the kinetic score per page. The prediction module 230 may then compare it to the Momentum graph, which is reader-generated, i.e., generated based on the interpretations. Further, the prediction module 230 may test whether the kinetic score line is predictive of the Momentum graph line. A point where the two lines diverge will reveal where the script falls short or exceeds predicted values. Exceeding prediction would mean that readers are engaged despite less active sentences, indicating the relationships or other story elements are keeping them interested. A typical case of falling short would be action media content, such as an action film with high kinetics that does not have engaging characters, i.e., lots of active sentences but little reader attachment to the story.

In some embodiments, the prediction module 230 is also configured to compute a screenplay quality score (SQS) for the screenplay based on the user behavior and the set of interpretations for the screenplay. As described earlier, the set of interpretations can include the set of character-related interpretations, the character appeal, the set of statistical parameters, and the like.

In an embodiment, the set of statistical parameters can include a character rating for each character in the screenplay, a section rating, character activity metric, character incidence per section, recommendations, comment categories, positive and negative word trends, momentum lags, favorite character, recurring issues in the screenplay, and the like. It is noted that the interpretation generation module 228 may generate the set of statistical parameters based, at least in part, on the textual data and the one or more user inputs.

In a non-limiting implementation, the prediction module 230 may compute the SQS by using the following formula:

$$S Q S = ( 0.20 * IDEA ) + ( 0.20 * C H A R ) + ( 0.15 * DIALOG ) + ( 0.15 * ORIG ) + ( 0.10 * EMOT ) + ( 0.1 * C L A R ) + ( 0.10 * S U S P ) \qquad Eqn . ( 2 )$$

Herein, the description of each parameter in Eqn. (2) is as follows:
IDEA=Idea (from “Idea” metric)
CHAR=Character Evaluation (from “Character Appeal” metric)
DIALOG=Dialogue (from “Character Dialogue” metric)
ORIG=Originality (from “Originality” metric)
MOT=Emotional Impact (from “Moving” metric)
CLAR=Clarity (from “Clarity” metric)
SUSP=Suspense (from “Suspense” metric)

It is noted that Eqn. (2) is subject to refinement through different weighting of each parameter (which are various interpretations of the screenplay) in the equation and data from reader responses to questionnaires when they complete the corresponding screenplay.

Further, in an embodiment, the formula of Eqn. (2) aims to capture the core strengths of the screenplay based on direct feedback categories. In a non-limiting implementation, Idea, Character, Dialogue, and Originality are fundamental pillars of a strong script, hence assigned higher weights. However, Emotional Impact (Moving), Clarity, and Suspense are factors that contribute significantly to a compelling and understandable reading experience, hence assigned moderate weights. It is noted that the sum of weights is about 1.00, making the score directly interpretable on the same scale as the input metrics (1-10).

For instance, if the values for the above-mentioned parameters are as follows:
Idea=6.92
Character Appeal=6.54
Character Dialogue=6.50
Originality=6.63
Moving=5.97
Clarity=6.30
Suspense=6.94

Then, upon substitution into Eqn. (2), i.e.,

$$S Q S = ( 0.20 * 6.92 ) + ( 0.20 * 6.54 ) + ( 0.15 * 6.50 ) + ( 0.15 * 6.63 ) + ( 0.1 * 5.97 ) + ( 0.10 * 6.30 ) + ( 0.10 * 6.94 )$$

The SQS in this example can be about 6.58. Thus, it may be understood that that the SQS score is a weighted sum of the interpretations determined by the server system 200. In a non-limiting example, the weights assigned to each parameter can be almost equal.

To that end, it is noted that, in an embodiment, the prediction module 230 may generate the prediction based at least on the kinetic score for each section and the SQS for the screenplay. Further, in an embodiment, the prediction may provide insights on an expected response from the one or more third users 108 who view the media content after a public release of the media content.

FIG. 3 illustrates a schematic representation 300 for a workflow, in accordance with an embodiment of the present disclosure. As may be understood, every reader's (e.g., the second users 106) actions are time-stamped. Interactions (i.e., the user inputs) of the second users 106 with the screenplay 302 constitute the user behavior, providing objective measures (i.e., the interpretations) that correlate strongly with subjective responses of the second users 106. For example, pausing during reading is a significant event. The server system 200 tracks and flags clusters of pausing. Free-form comments are summarized using the ML models 220. The combination of reader demographics, page responses, free-form comments, and the user behavior provides the basis for various analyses of the storyline or the screenplay 302 under test, for which the first user 104 may have to prepare the media content (e.g., a filmed entertainment).

In a non-limiting implementation of the workflow, the second users such as the second users 106A, 106B, and 106C may be selected for reading the screenplay 302 and providing their inputs which are referred to as the user inputs. In an embodiment, the second users 106A, 106B, and 106C may read the screenplay 302 on their respective electronic devices such as the electronic devices 304A, 304B, and 304C, respectively (collectively referred to as ‘electronic devices 304’). In such an embodiment, the second users 106A-106C may read the screenplay 302 on their electronic devices 304A-304C through a platform that facilitates displaying the screenplay 302 on the corresponding devices 304A-304C. In an example implementation, the platform can be a website, a website application, a software application, or the like. It is to be noted that the platform merely displays the screenplay 302 to the second users 106A-106C and restricts them from downloading the same on their respective electronic devices 304A-304C.

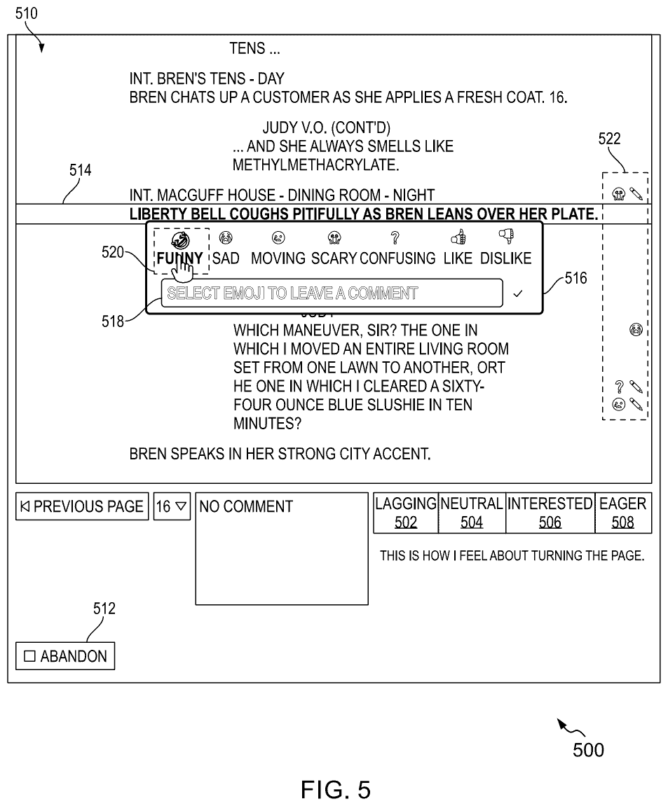

In one embodiment, the following are some of the steps of the workflow:
1. Receiving the screenplay 302 corresponding to the media content when a client of the server system 200 such as the first user 104, uploads the screenplay 302 in a certain format such as a PDF format.
2. Parse and analyze the received screenplay 302 by performing the following operations:
   a. Textual data is extracted from the screenplay 302.
   b. Segment the textual data into multiple sections (or multiple pages) for displaying one section (or one page) at a time to the second users 106A-106C.
   c. Count the number of words per section such as per page.
   d. Determine script elements (scene, dialogue, description, etc.)
   e. Determine main characters (frequency count).
   f. Determine character appearance per page.
   g. Determine character dialogue per page.
   h. Determine the number of sentences per page.
   i. Score each sentence for “activeness”.
   j. Determine scores for sentence kinetics using NLP.
   k. Determine the kinetics ratio per page.
   l. Character networks mapped—verifying main character determination, with main characters central in networks, even if they speak very little. These results can collectively be referred to as character+words per page data 306.
3. This parsed data is imported into the database 110 via the third-party platform and linked to the script record, forming the foundational metadata. The purpose of this step is to convert the raw, unstructured format of the screenplay 302 into machine-readable, structured data. This structured data serves as the objective baseline of the script's composition. It enables comparisons such as:
   Script prominence v/s perceived importance: A character that appears on, for example, 3% of pages but receives the majority of emotional feedback.
   Structural pacing v/s reading drop-off: Identifying if certain script sections cause readers such as the second users 106 to disengage.
   It is noted that this comparison between “what is written” and “how it is perceived” provides a new dimension in script diagnostics.
4. The server system 200 performs reader synchronization and status update by performing the following steps:
   The server system 200 connects to the API and retrieves the latest list of readers such as the second users 106, from the third-party platform.
   This list is populated into the database 110 with fields, such as name, email, demographic information, prior participation, current availability, and the like.
   Operational users such as the first user 104 may mark whether each reader is active or inactive via checkboxes in the first UI.
5. The server system 200 is configured to obtain consent from the second users 106 by performing the following steps:
   The server system 200 sends personalized emails to the active readers, inviting them to participate in the review of the new script such as the screenplay 302.
   Each recipient can confirm or decline participation.
   Their response is logged in the database 110 in real time.
6. Readers such as the second users 106 who have approved their participation are pushed into the database 110 of the server system 200. Recruit/select readers such as the second users 106 based at least on demographic-based screening and film preference screening (hereinafter, otherwise also referred to as ‘genre-based screening’). The server system 200 filters the second users 106 based on client (i.e., the first user 104) preferences for reader demographics, selecting from a reader population, readers by age, location, gender, etc. The server system 200 also filters the second users 102 based on the genre of the screenplay 302 to receive the most effective and useful information from the first user 104.
7. The server system 200 then sends links to the screenplay 302 in the form of sections on the electronic devices 304 of the second users 106. Only these selected readers can see that the screenplay 302 is on the website facilitated by the server system 200. For instance, the links for the screenplay 302 can be sent via an email. More specifically, the server system 200 can send emails to the second users 106 at different stages of the workflow. The server system 200 also possesses mass emailing capabilities for post-project follow-up or promotional updates. The server system 200 can also track critical email metrics, such as open rate, click-through rate, bounce status, unsubscribes, and the like. It is noted that all email activity is logged in the database 110 for full lifecycle visibility and auditability. Compliance with deliverability is taken care of by the server system 200.
8. Reader demographics are collected or verified. User Agreement checkboxes promising confidentiality must be clicked for the script pages to become visible.
9. Readers read on the website. All actions are time-stamped.
   a. As the readers read the screenplay 302, the server system 200 monitors the reading speed. If one of the second users such as the second user 106A exceeds the set threshold for reading speed per page, an alert is sent to them warning that they must read diligently. As a result, people who pretend to read can be filtered out, improving the quality of the data, i.e., results generated by the server system 200.
   b. Reading speed is measured against the speed of other readers of those pages and the screenplay 302, flagging names who are outside one standard deviation in speed. To avoid false data, in an embodiment, the server system 200 detects overly fast second users 106 and drops them from the readers list.
   c. The reading path of the second users 106 is also tracked (e.g., page views, time spent per page, scrolling behavior, etc.). Inline reactions (e.g., emoji, rating scales, etc.) are recorded at a granular level per script line. Further, textual commentary and structured ratings are submitted at various checkpoints.
   d. The server system 200 also facilitates the second users 106 to provide freeform comments or emojis for each line in each section of the screenplay 302 being displayed to the second users 106. For instance, the second users 106 can click on a line in the screenplay 302 and be offered a choice of emojis and/or a freeform comment box (as shown in FIG. 5).
   e. Readers are shown one page or other section at a time. In order to turn the page, Readers click on one of the buttons below the screenplay 302, such as ‘lagging’, ‘neutral’, ‘interested’, or ‘eager’, which forms the basis for the Momentum graph line.
   f. If a reader, e.g., the second user 106B does not click a response button at the bottom of any page for a defined period of time, the server system 200 may register that as a pause. In a non-limiting example, the defined period of time for the pause can be about 2 to 3 minutes. When the reader returns to the site, they are taken to the last page they were on, and a pop-up box asks the pause-related questions mentioned earlier.
   g. In the considered example, the 2 to 3-minute rule applies only when the pop-up window appears. General pause data is derived from the overall time-stamped events without a predefined duration that denotes a pause.
   h. When the reader responds to the last page in the screenplay 302, they are taken to a survey.
10. The time stamps, demographics, responses of the readers, and all the other data are collected in the database 204. In an example implementation, based on further inspection, the admin or the first user 104 can accept or decline a reader's data. If data is not accepted, an automatic email goes out informing the reader, i.e., the second users 106, of their violation of the user agreement and informing them they will not be compensated for their reading.
11. All the user inputs are analyzed using the ML models 220, and the analysis includes, but is not limited to, the following:
   a. Generate a momentum graph.
   b. Generate time-series data.
   c. Generate responses by demographics.
   d. Perform statistical tests for P-values. Herein, a null hypothesis, which is a part of Z data analysis 308 is performed.
   e. Generate graphs.
   f. Generate AI summaries of freeform comments.
12. The first user 104 reviews the data, looking for higher-level patterns and correlations. An example is the aforementioned conclusion that the female lead is not working for readers. This generates further inquiries within the data.
13. As an example, the second users 106 are compensated if:
   a. They appear to have read at least about 66% of the screenplay 302 before the deadline.
   b. Time stamp analyses indicate they did not have excessively fast reading speeds.
   c. They have completed the demographic and final response forms.
14. A report is delivered to the client, i.e., the first user 104, which may include the raw data in graph or table form plus an analysis of the meaning of that data.

In a non-limiting implementation, the server system 200 is configured to determine the interpretations, including the user behavior, the set of character-related interpretations, and other interpretations. By way of an example and not by limitation, the determination of the interpretations is AI-driven with ChatGPT and Natural Language Processing (NLP) tools. More specifically, as per the same example, ChatGPT can be used in the following ways:
Filter-based commentary analysis: The first user 104 can filter reader feedback by demographic or behavioral tags, e.g., “How did readers aged 18-24 from low-income backgrounds rate the protagonist in the screenplay?”.
Character-focused sentiment tracking: The server system 200 can isolate all mentions and opinions about a specific character and synthesize themes (e.g., “Why was the antagonist perceived as confusing in the screenplay?”).
Thematic extraction and clustering: The server system 200 identifies recurring topics, contradictions, or standout lines of text.
Bias detection: The server system 200 reveals how different reader groups interpret the same scenes differently.

It is noted that these capabilities turn qualitative feedback into quantifiable insights. More specifically, the server system 200 is configured to perform internal aggregation of metrics, such as average reader sentiment per page, character approval ratings, drop-off curves, and the like. In an example, these metrics can be visualized and filtered using grouped views, filters, and summary bars. In a non-limiting implementation, for advanced statistical modelling, all data can be downloaded as structured CSV files. This enables external analysts to perform regression models, comparative testing, or data visualization. Further, Natural language feedback can be filtered and interpreted, using the ChatGPT, based at least on identifying patterns of confusion, excitement, or emotional resonance, and receiving group comments by reader traits for sociological or market research.

In some embodiments, the workflow can include additional operations that the server system 200 is configured to implement. In a non-limiting implementation, these additional operations can include:
Reader Validation and Cleansing: The server system 200 is configured to clean the scripts and standardize email addresses, merge duplicates, and correct formatting errors in names or demographics.
Outlier Filtering: The server system 200 automatically flags and excludes data from readers who abandon the script early or exhibit erratic reading patterns.
Audience Filtering for Campaigns: The server system 200 supports segmentation of readers based on custom tags, enabling highly targeted follow-up campaigns.
Auditability: All actions, such as script reads, API calls, emails sent, and feedback submitted, are logged and timestamped for full transparency.

In an embodiment, the server system 200 is configured to categorize the comments as positive, negative, or neutral. Further, the server system 200 may detect frequently referenced ideas or characters in the screenplay 302. These operations may be performed to check whether the information rises to a level of significance worth reporting to the first user 104 about the prediction.

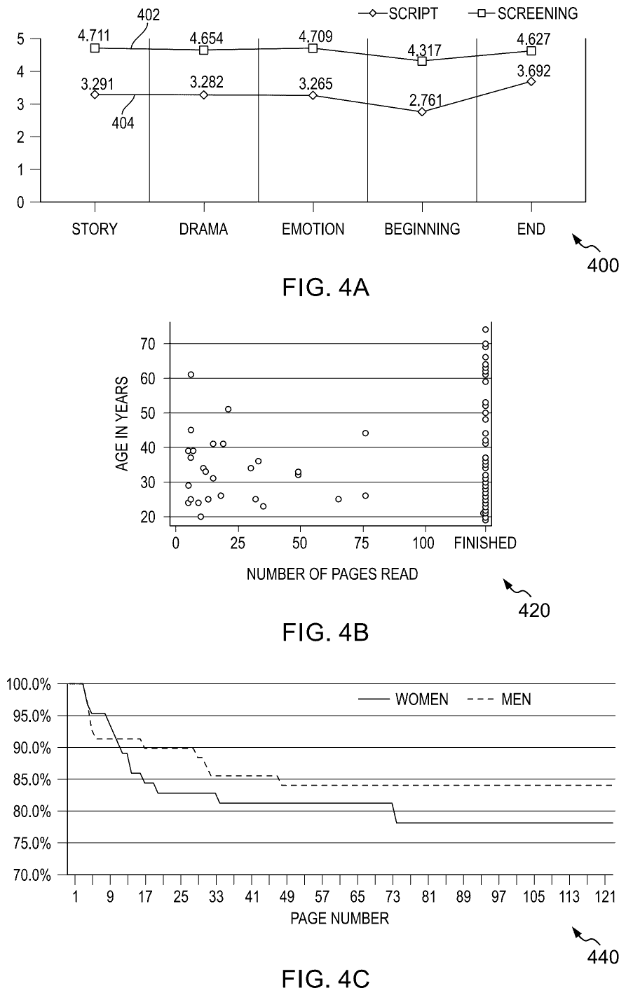

FIG. 4A illustrates a graphical representation 400 of a comparison of a reader's rating (e.g., the rating provided by a second user such as the second user 106A) with test screening data, in accordance with an embodiment of the present disclosure. As described earlier, the objective of the server system 200 is to provide information such as the quality of the media content, predict whether the third users 108 might like the media content when released, predict whether the third users 108 will connect with the media content prepared from the screenplay 302 under test, and the like. More specifically, the server system 200 is configured to provide this information at a much earlier stage of the media content-making process, when intervention is more cost-effective and efficient, i.e., during the writing stage when the screenplay 302 is being prepared. The server system 200 applies statistical analysis to the reader's responses, behaviors, and demographics to provide an early look at the future audience response.

In an embodiment, in order to check the effectiveness of the proposed approach, the readers' rating obtained from the server system 200 can be compared with the future test screening data that may be associated with the screenplay 302 under test. Thus, as an example, the graphical representation 400 is shown in FIG. 4A compares the readers' ratings (i.e., the second users 106′ ratings) of a particular screenplay 302 for which the test screening data is also obtained. The survey questions of the test screenings that may be performed on the media content prepared from the screenplay 302 may be matched with the readers' surveys. Herein, it is to be noted that the readers (i.e., the second users 106) have not seen the media content and did not know that the screenplay 302 belongs to a released media content. The readers and the viewers are asked to rate specific story elements, as seen in the chart shown in FIG. 4A. Examples of the story elements include, but are not limited to, story, drama, emotion, beginning, end, and the like.

Moreover, as per the example implementation, a top line (see, 402) in FIG. 4A shows the averaged responses of the screening audiences on a scale of about 1-5 (with 5 being the most positive). A bottom line (see, 404) shows readers' responses. It may be observed that the readers rated the script an average of about 1.3 points lower than viewers of the media content.

However, it is to be noted that the two lines (i.e., the top line 402, and the bottom line 404) have a matching shape. The responses of the readers followed the same pattern as the responses of the viewers. The similarity of this pattern validates the idea that readers' responses can be a predictive tool before greenlighting or approving this media content for public release.

Further, a rise in a line (i.e., the bottom line 404) towards the end in the readers' responses, with the highest average score of about 2.85 out of 4, is observed. This indicates that, while readers were not enthused about the end, they certainly liked it much more than the script's first half. In a non-limiting implementation, the following table shows the raw scores of page responses:

TABLE 1
Raw scores of page responses

| | Number of Pages | Percent of Pages |
|---|---|---|
| Lagging | 2,686 | 13.99 |
| Neutral | 5,877 | 30.61 |
| Interested | 8,538 | 44.47 |
| Eager | 2,100 | 10.94 |

It may be noted that the values in Table 1 are approximate values and may vary based on variations in the experimental conditions. It may be observed that, in this particular scenario, there are more “Lagging” scores than “Eager”, which is evidence that the script is not sufficiently engaging. The highest score is “Interested,” which is a clue that the story has unfulfilled potential.

FIG. 4B illustrates a graphical representation 420 of a failure analysis indicating a drop-off by age, in accordance with an embodiment of the present disclosure. As described earlier, drop-off is an interpretation generated upon selection of the ‘Abandon’ option by any of the second users 106 via their respective electronic devices 304. Further, it may also be noted that the drop-off is defined as the page (or section) in the script on which a reader chooses to stop reading, or “abandon” the script. As the global market shifts towards streaming, script drop-off is a likely indicator of when the content viewers (i.e., the third users 108) will “click out” of the media content, such as a movie or an episode of a series.

It is noted that age is a large factor in the completion of the script. Referring to FIG. 4B, it is understood that each dot in the graphical representation 420 such as the scatter graph, represents age (in years) and the highest number of pages read. The dots on the far right represent the second users 106, who finished the script. It may also be noted that the cluster of people (bottom left) under age 40 years are the second users 106, who stopped reading before page 20. It may be interpreted that the media content that may be filmed might either not emotionally connect with the third users 108 or the third users 108 might not find it interesting. Moreover, it may be noted that the results shown in FIG. 4B are approximate results of an experiment conducted on a group of second users such as the second users 106 of different age groups. The results may vary with the experimental setup and various experimental conditions.

FIG. 4C illustrates a graphical representation 440 of the failure analysis indicating a drop-off by gender, in accordance with an embodiment of the present disclosure. In a non-limiting example, the variation in drop-off can be observed with respect to gender as well. Upon conducting an experiment, it was observed that out of 64 women, 16 (i.e., about 25%) dropped. Further, out of 69 men, 12 dropped (i.e., about 17.4%). Moreover, it may be noted that the results shown in FIG. 4C are approximate results of an experiment conducted on a group of second users such as the second users 106 of different gender groups. The results may vary with the experimental setup and various experimental conditions.

Further, it may be observed that more females than males stopped reading early in the script. In fact, 17% of female readers dropped by page 21. There was another visible drop-off among females around page 76. Losing 5% of females after the sunk cost of reading this far, plus forgoing payment for the reader, makes this especially significant. This drop-off leads to an examination of the female leads in the script. The drop-off curve for female readers (i.e., the second users 106 that are female) is the first clue that there might be a problem with the female lead because the pages with drop-off include a scene in which the female lead is a key character.

Further, the reader responses (i.e., responses of the second users 106) to the pages in which the female lead appears may also be observed to check if the momentum of the second users 106 is lower for those pages. The freeform comments may also be checked to see if any of the second users 106 registered specific objections to the portrayal of that character. According to a non-limiting example, all of these measures may indicate that the second users 106 did not connect with the female lead. They felt the issues of the female lead were tacked on and not genuine.

In another non-limiting example, if a soft response to the male lead, i.e., the husband of the female lead, may have been received, then it can also lead to further investigation of the situation. In yet another non-limiting example, the strongest responses, with no drop-off, plus higher momentum, can be associated with pages in which the second male lead appeared. Suppose this character was mentored by the heroic lead. Thus, all these clues together can indicate the first user 104, i.e., the content creator or the writer, to conclude that the storyline should have been centered more on the second lead and anybody related to that lead. Restructuring the storyline around the second lead would have been relatively easy and would have made the media content more successful if the second lead had become the focus. Thus, the interpretations obtained using the approach disclosed in the present disclosure can be helpful to the first user 104 to restructure the storyline in the screenplay such that the media content, when prepared, is more interesting to the third users 108 than the initial storyline.

FIG. 5 illustrates a UI 500 displayed to the second users 106, in accordance with an embodiment of the present disclosure. As described earlier, one of the key metrics of the present disclosure is to capture its audience engagement with the screenplay (e.g., the screenplay 302), based on how the readers such as the second users 106 feel about continuing to read. In one embodiment, to turn the page (or move to the next section of the screenplay 302), the readers click one of four buttons that reflect how they feel about turning the page: Lagging 502, Neutral 504, Interested 506, or Eager 508. When clicked, the next page is displayed, and so on until the reading is finished. These four buttons are shown in the UI 500 shown in FIG. 5. The UI 500 shows a section 510 of the screenplay 302 that is currently being read by a second user such as the second user 106A, while reading or at the end of reading the second user 106A have to press any of the above-mentioned four buttons to proceed with the next section. However, if the second user 106A is not willing to continue to read further, the second user 106A can press the button ‘abandon’ (see, 512), and the UI 500 changes to a survey that generally appears at the end of the screenplay 302. The second user 106A can simply fill up the end survey with their opinion about the storyline or the screenplay 302 and their reasoning for abandoning to read further at a particular point.

In an embodiment, the UI 500 also facilitates the readers to select each line (e.g., a line 514, as shown in FIG. 5) in the screenplay 302 per section (e.g., the section 510). Upon selection of the line 514, a choice for emojis pop-up 516 appears on the UI 500 along with a freeform comment box 518. The reader can enter the comments for each line in the freeform comment box 518 and select any of the emojis (e.g., a funny emoji 520, as shown in FIG. 5) displayed in the choice for emojis popup 516. Upon selection of the emoji such as the funny emoji 520, the selected emojis may appear on the right side of the UI 500 as shown in FIG. 5 (see, 522).

In one embodiment, it is to be noted that the data obtained upon the pressing of any of the four buttons, or the ‘Abandon’ button in the UI 500, can be represented using the momentum graph (as shown in FIG. 6A). It is the key measure of the second user's 106A engagement with the storyline. Each reader of each screenplay 302 generates a graph line for momentum, which is averaged in this sample as shown in FIG. 6A.

Referring to FIG. 6A, illustrates a graphical representation 600 of variation of momentum indicating an engagement of a second user such as the second user 106A, with the screenplay 302, in accordance with an embodiment of the present disclosure. As may be understood, momentum is a key metric, or a key interpretation made by the server system 200. Asking readers, i.e., the second users 106 to indicate how they feel about turning each page with the simple click of the button is a low-friction action (minimally interferes with reading) and provides vital information about readers' engagement with the storyline. As may be understood, generally, people are accustomed to turning physical pages, so requesting an action (the button selection) at that point has minimal interference with the act of reading, just as turning a physical page is not perceived as an interruption.

It is to be noted that momentum does not provide the reason behind the engagement of the readers with the storyline, and there can be tremendous variation in individual clicks. But in aggregate, the Momentum line (see, 602) is shown in FIG. 6A, provides a glimpse at an overall engagement with the storyline, with averaged peaks and lags becoming visually obvious. FIG. 6A shows page numbers along the bottom of the graphical representation 600, i.e., the x-axis. The y-axis expresses the average of how readers feel about turning the pages on a scale of 1-4 (labeled in FIG. 6A as ‘average rating per page’).

FIG. 6B illustrates a graphical representation 610 of the behavior of the second users 106 interested in reading the screenplay 302 after each pause, in accordance with an embodiment of the present disclosure. As described earlier, detecting when the readers such as the second users 106, pause or lose interest while reading the screenplay 302 can provide valuable insights into what elements of the narrative are resonating or falling flat. Therefore, developing robust techniques for pause detection is crucial.

One important piece of information stored by the server system 200 is a pausing time. The server system 200 is configured to save the timestamps when the second users 106 completes each page. In an embodiment, the distribution of average pause time with respect to each page in the screenplay 302 can be represented in the form of a plot or a graphical representation 630 (as shown in FIG. 6D). This plot provides an insight into which pages have a greater number of pauses and more average pause time. These timestamps can be used to determine the time spent on each page. In another embodiment, the frequency of pauses with respect to the page reading time can also be represented in the form of a plot or a graphical representation 620 (as shown in FIG. 6C). One important indicator is pausing, i.e., if readers pause in mass on a certain page, it strongly indicates audience disinterest. In other words, pages with a high frequency of pausing indicate that the audience is more likely to be least interested in the storyline covered in the corresponding pages. Pause data can not only be used to prompt readers for feedback but also to analyze engagement patterns, identify problematic script sections that need revision, and optimize narratives.

It is to be noted that pause detection requires two separate determinations. First, the existence of a pause must be determined from the timestamps as shown in FIG. 6D. While one could establish a global threshold, designating page reading time period being greater than this as pauses is overly simplistic. More sophisticated estimations account for the length and content complexity of each page, as well as the reading speed and overall page completion time distributions of individual users, as shown in FIG. 6C.

Statistical techniques include probabilistic models such as the ML models 220 that infer the likelihood of each duration being an intentional pause versus normal reading time. In one embodiment, the ML models 220 such as ML classifiers, could also be trained on labeled data to discriminate pauses. Examples of the ML models 220 include Hidden Markov Models and random forest classifiers.

In this process, the key challenge can be differentiating intentional pauses indicating disengagement from temporary stops due to external distractions. The server system 200 has just implemented prompting, i.e., when a pause is detected, a prompt is sent to the reader such as the second user 106A, asking them to explain the pause by posing the question as ‘was it because they lost interest, or due to external factors?’. Responses to such questions provide ground truth data to improve pause classifiers.

Second, when pauses are detected from page reading time data, a model such as one of the ML models 220 determines if a statistically significant accumulation of pauses has occurred, beyond expected random variance. This step can be referred to as a pause time significant test. In accordance with some embodiments, plots corresponding to some of the pause time significant tests are shown in FIG. 6E and FIG. 6F.

Referring to FIG. 6E, illustrates a graphical representation 640 of the results of a pause time significant test, in accordance with an embodiment of the present disclosure. Herein, the pause time significant test corresponds to a Mann-Whitney test. The plot generated using this test corresponds to a plot of P-values for each page in the screenplay 302. The Mann-Whitney test first ranks all the values from low to high and then computes a P-value that depends on the discrepancy between the mean ranks of the two groups. Herein, the portion in the plot above the horizontal dotted line represents ‘no significant difference in pausing amount’ and the portion below it represents ‘a significant difference in pausing’. Moreover, since most of the pages differ from the total distribution, this may not be a good metric. Thus, another type of test may be performed as explained with reference to FIG. 6F.

Referring to FIG. 6F, illustrates a graphical representation 650 of the results of a pause time significant test, in accordance with another embodiment of the present disclosure. Herein, the pause time significant test corresponds to a Kolmogorov-Smirnov (K S) test. The plot generated using this test corresponds to a plot of P-values for each page in the screenplay 302. The K S test compares the cumulative distribution of the two data sets and computes a P-value that depends on the largest discrepancy between distributions.

Returning to FIG. 6B, the naive null model, where pauses are independent and identically distributed, is insufficient. The time since the last pause, the length of the script, and the page content may all affect the underlying pause distribution. Accurate and robust pause detection capabilities can provide the server system 200 with rich insights into audience engagement. As may be understood, two factors about pausing may be interesting, such as checking for the following questions: ‘Are the reading pauses caused by the screenplay 302, or external factors?’ and ‘how does the reader feel about returning the screenplay 302?’.

If the second user 106A does not click to turn the page for a set period of time, when they return to the screenplay 302 a pop-up window asks questions shown in the following Tables:

TABLE 2
First question
We noticed you stopped reading. Please tell us why you paused.

For reasons unrelated to the reading
To take a break from reading

TABLE 3
Second question
And how do you feel about resuming reading?

Eager
Interested
Neutral
Dragging myself back

The first question (as per Table 2) allows the server system 200 to aggregate the number of pauses on a particular page or set of pages and filter the reasons for pausing. This allows a closer look at pauses related to the reading, rather than some outside interruption. The second question (as per Table 3) indicates the server system 200, the enthusiasm with which the reader is reading, which is another measure of momentum. Further, the readers pause for many reasons, but patterns in pausing are meaningful in this case. In some embodiments, a pause is defined as taking more than two minutes before turning a page.

In one embodiment, the server system 200 is configured to pose a question to the readers about the reasons for their pausing, i.e., the first question, and the following results can be obtained as per an example experiment:

TABLE 4
Results for the first question
What was the most common reason for you to pause in reading?

| | |
|---|---|
| Paused for reasons unrelated to the script | 45.03% |
| I would sometimes lose interest or feel tired, | 28.65% |
| but I wanted to return | |
| I would lose interest and not want to return to the script | 26.32% |

In another embodiment, the server system 200 may be configured to impose another question on the readers, such as the second question, i.e., How did you feel about returning to the script after a pause?

The following table shows the results obtained for the second question as per an example experiment:

TABLE 5
Results for the second question

| | |
|---|---|
| Dragged myself back | 22.81% |
| Uninterested | 8.77% |
| Mildly interested | 35.09% |
| Interested | 29.24% |
| Eager | 4.09% |

It is to be noted that, based on the results shown in Tables 4 and 5, the server system 200 may generate an interpretation related to the user behavior. Herein, the user behavior indicates whether the reader seems to connect with the storyline or not. By way of an example, and not by limitation, the results shown in Table 5 may have been plotted as shown in FIG. 6B. In FIG. 6B, the number on the x-axis may indicate the number of readers.

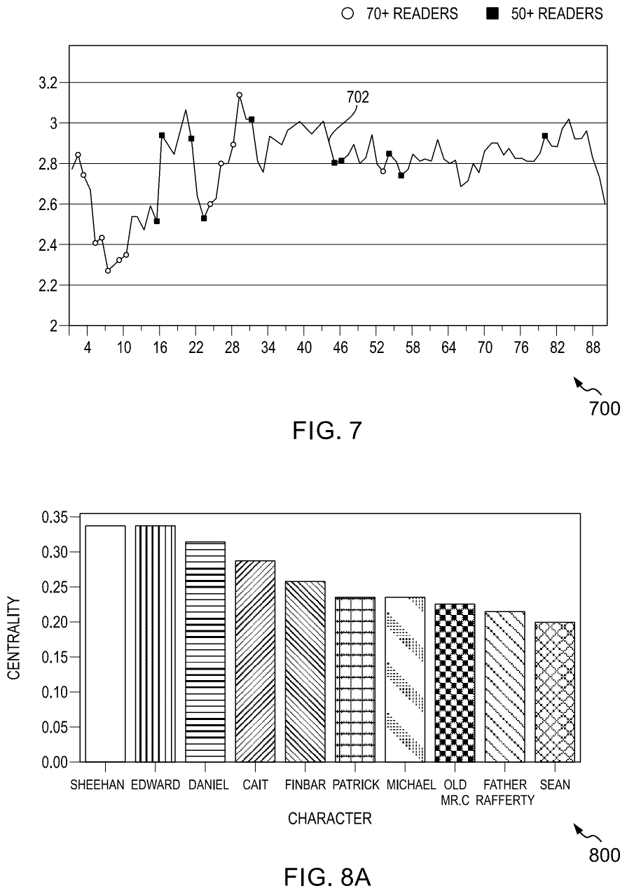

FIG. 7 illustrates a graphical representation 700 of a pause plus momentum plot, in accordance with an embodiment of the present disclosure. The pause plus momentum plot combines a momentum graph with pause events. Note the cluster of over 350 pause events around page 7, which helped to formulate a relationship between pausing and momentum. The average momentum line (see, 702) is combined with clusters of pauses on particular pages indicated by dots with a preferred pattern or shape.

This graph, as shown in FIG. 7 clearly indicates some issues between pages 4 and 12. Since each circular dot indicates more than 70 readers pausing there, this means over 350 (5 circular dots×70) readers paused during their reading of those pages. The reason for their pausing is not known, but when it has been observed that these pauses correspond with the lowest momentum scores, a conclusion can be made that there is some story or writing problem in that section of the script.

Further, it is to be noted that the likely story issues are unknown from just this graph, but when combined with other types of responses, specific causes for the story not connecting with readers here can be predicted. An unproven, but reasonable, assumption is that pausing and momentum data will correlate with “clicking away” during streaming of media

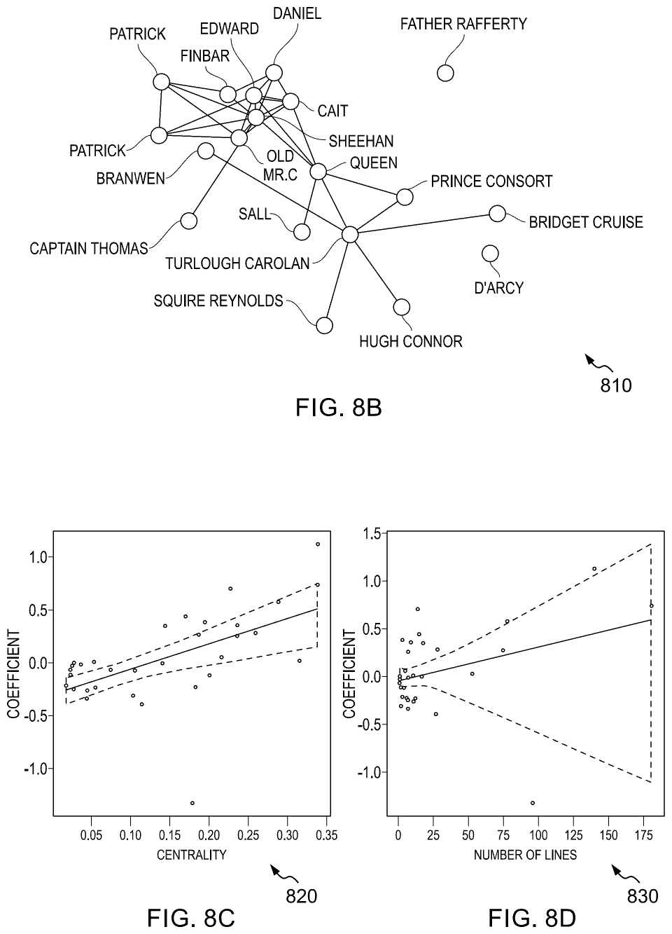

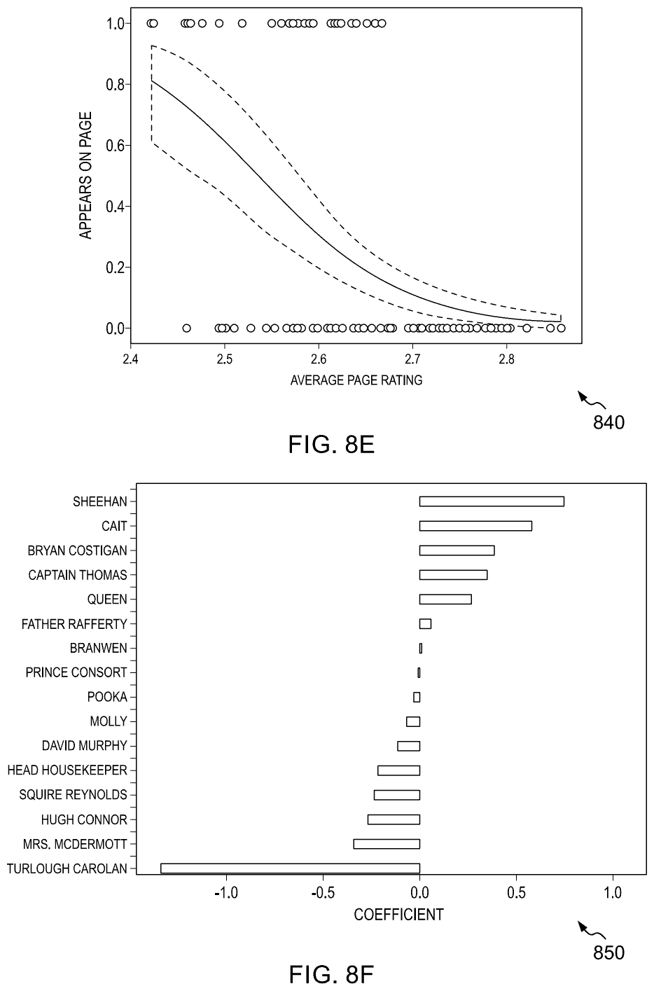

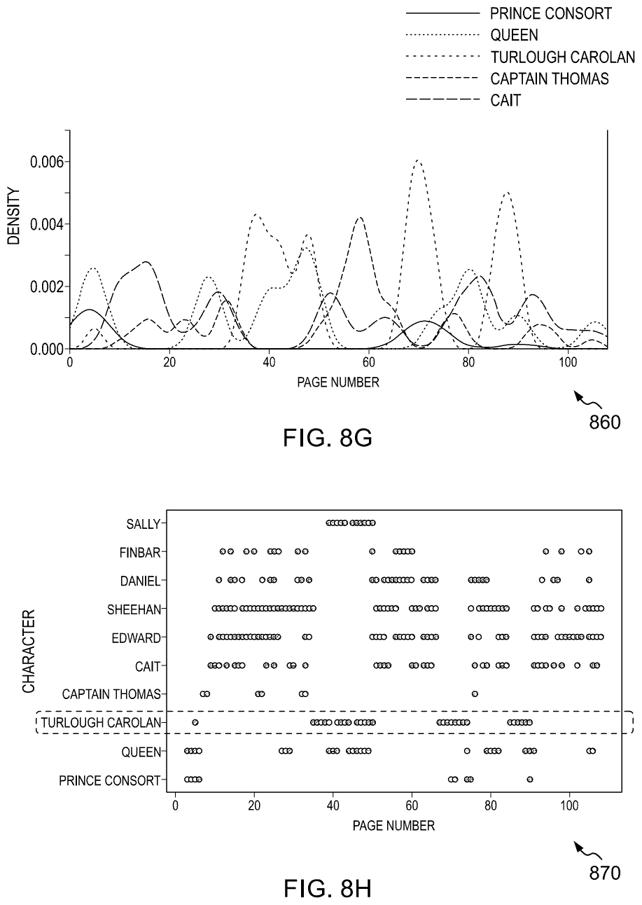

FIG. 8A illustrates a graphical representation 800 of the centrality of characters in the screenplay 302, in accordance with an embodiment of the present disclosure. As may be understood, understanding the roles, relationships, and dynamics between one or more characters in a screenplay such as the screenplay 302 is crucial for analyzing narrative structure and audience engagement. The character network analysis provides a powerful quantitative framework to model and study these elements. In one embodiment, the server system 200 is configured to quantify the nature and dynamics of the characters in new and innovative ways that shed light on what narrative structures are effective and resonate with audiences.

In an embodiment, one of the measures is to generate a character network 810 (as shown in FIG. 8B) between one or more characters of the screenplay 302. Character networks offer quantified interactions between the characters. Nodes in the character network 810 represent the characters, and edges represent their interactions. The research literature has demonstrated how the content, traits, and relationships of the characters can be quantified and understood through these networks. They highlight the most important characters narratively and quantify the script's overall structure. While traditional character analysis relies on hand-coded data, recent work (i.e., the proposed approach) has automated the process of extracting character networks from the textual data. A naive approach assigns an edge when two characters appear in the same scene or page. However, advances in NLP enable more nuanced interaction quantification.

As described earlier, the character network 810 is constructed by representing each character as a node in the network. The connections (edges) between these nodes are established based on the co-occurrence of the characters within scenes. Specifically, if two characters appear together in a scene, an edge is created between them. The strength or weight of this edge can be quantified by the number of times these characters appear together across the narrative, indicating the strength of their relationship or interaction frequency. This method effectively transforms qualitative narrative data into a quantifiable structure, allowing for systematic analysis using various network analysis tools and techniques.

To that end, once the character network 810 is established, centrality metrics can be applied to identify the most influential characters within the story, as shown in FIG. 8A. In a non-limiting implementation, one such metric is Eigenvector Centrality, which measures a character's influence not just by the number of direct connections (or co-occurrences) they have, but also by the influence of the characters they are connected to. This method is akin to the PageRank algorithm, where a character is considered more central if they are connected to other central characters, thus reinforcing their role and importance in the narrative. It is to be noted that Eigenvector Centrality is particularly useful in narratives where some characters may not appear frequently but play crucial roles by linking together disparate story arcs or groups of characters.

FIG. 8C illustrates a graphical representation 820 of the character centrality versus appeal in the screenplay 302, in accordance with an embodiment of the present disclosure. FIG. 8D illustrates a graphical representation 830 of character total lines versus appeal in the screenplay 302, in accordance with an embodiment of the present disclosure. Character appeal can be assessed by analyzing how audience reception (e.g., ratings or viewer engagement) varies with the appearance of the characters (as shown in FIG. 8E for a particular character such as Turlough Carolan, see, 840). By applying logistic regression, where the dependent variable could be audience ratings and the independent variable of the presence of a character, the impact of a character's presence on audience ratings can be determined as shown in FIG. 8E. The regression coefficient, in this case, provides a numerical value indicating the extent to which a character's presence contributes to higher or lower ratings, effectively quantifying their appeal.

The interplay between a character's centrality in the narrative structure and their appeal with audiences can yield deep insights. Characters who are central to the character network 810 might be expected to be popular, but this is not always the case. By analyzing both centrality and appeal, one can identify characters who, despite being central, might not be well-received by the audience, and vice versa. This analysis can guide content creators in making informed decisions about character development, narrative adjustments, and even marketing strategies.

For instance, a character who has high eigenvector centrality but lower appeal might need more engaging story arcs or a better portrayal to enhance audience connection. Conversely, a character with high appeal but lower centrality could be developed into a more central figure in the story to leverage audience interest.

Character network analysis, through the creation of networks from scene co-occurrence data and the application of metrics like eigenvector centrality, provides a powerful tool for narrative analysis. When combined with quantitative assessments of character appeal through logistic regression, it allows storytellers and analysts to gain a holistic understanding of character dynamics and audience engagement. This integration of centrality and appeal enables a deeper appreciation of what narratives resonate with audiences and how characters drive those narratives.

FIG. 8F illustrates a graphical representation 850 of the effect of character presence on page rating in the screenplay 302, in accordance with an embodiment of the present disclosure. It is to be noted that based on the character rating of each character in each page in the screenplay 302, the page rating can be obtained. Thus, the coefficient plotted in FIG. 8F can be used to quantify the appeal of all the characters in the screenplay 302.

FIG. 8G illustrates a graphical representation 860 of character activity of one or more characters in the screenplay 302, in accordance with an embodiment of the present disclosure. In one embodiment, the character activity can be quantified by measuring the density of each character on each page in the screenplay 302. Herein, the density of the character is computed based on the intensity of the character's appearance on each page. Thus, it may be understood that the more the character appears on each page, the more the character activity may be observed on the corresponding page of the screenplay 302.

FIG. 8H illustrates a graphical representation 870 of character incidence per page of one or more characters in the screenplay 302, in accordance with an embodiment of the present disclosure. It is to be noted that the character incidence per page for each character may be associated with a dialogue intensity pattern as shown in FIG. 8H. The characters that are linked with each other may have a certain extent of appeal and have a dialogue intensity pattern that is similar to each other. However, characters that are outliers can have a different dialogue intensity pattern. For example, the character ‘Turlough Carolan’ has a totally different pattern of character occurrence as well as a different dialogue intensity pattern as marked in FIG. 8H. The report generated from this data suggested eliminating or minimizing the appearances of this character.

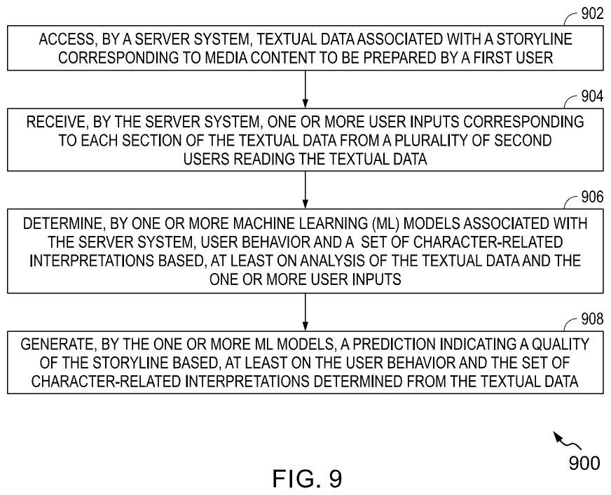

FIG. 9 illustrates a process flow diagram depicting a method 900 for determining the quality of media content, in accordance with an embodiment of the present disclosure. The method 900 depicted in the flow diagram may be executed by, for example, the server system 200. The sequence of operations of the method 900 may not necessarily be executed in the same order as they are presented. Further, one or more operations may be grouped and performed in the form of a single step, or one operation may have several sub-steps that may be performed in parallel or in a sequential manner. Operations of the method 900, and combinations of operations in the method 900 may be implemented by, for example, hardware, firmware, a processor, circuitry, and/or a different device associated with the execution of software that includes one or more computer program instructions. The plurality of operations is depicted in the process flow of the method 900. The process flow starts at operation 902.

At 902, the method 900 includes accessing, by a server system (e.g., the server system 200), textual data associated with a storyline corresponding to media content to be prepared by a first user (e.g., the first user 104).

At 904, the method 900 includes receiving, by the server system 200, one or more user inputs corresponding to each section of the textual data from a plurality of second users (e.g., the second users 106) reading the textual data.

At 906, the method 900 includes determining, by one or more Machine Learning (ML) models (e.g., the ML models 220) associated with the server system 200, user behavior and a set of character-related interpretations based, at least on analysis of the textual data and the one or more user inputs. In a non-limiting example, the ML models 220 are invoked; however, they may not always be used. Rather, the textual data and the user inputs captured are unique using one or more statistical models. Further, the ML models 220 facilitate a qualitative analysis of the textual data.

At 908, the method 900 includes generating, by the ML models 220, a prediction indicating a quality of the storyline based at least on the user behavior and the set of character-related interpretations determined from the textual data.

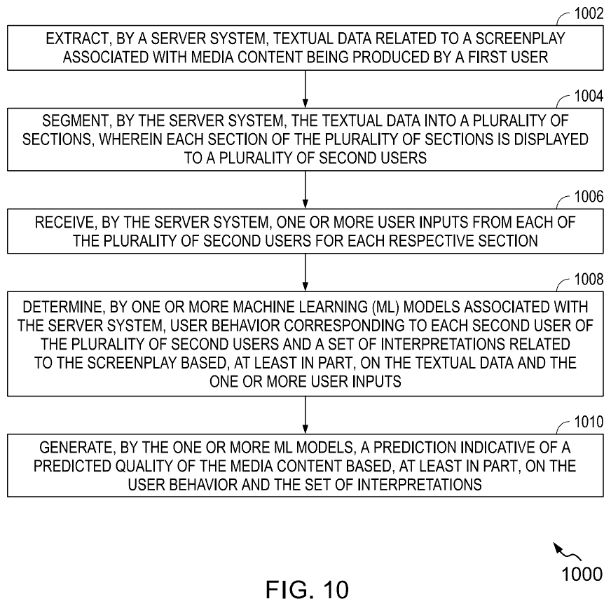

FIG. 10 illustrates a flowchart depicting a method 1000 for determining a quality of media content, in accordance with an embodiment of the present disclosure. The method 1000 depicted in the flow diagram may be executed by, for example, the server system 200. The sequence of operations of the method 1000 may not necessarily be executed in the same order as they are presented. Further, one or more operations may be grouped and performed in the form of a single step, or one operation may have several sub-steps that may be performed in parallel or in a sequential manner. Operations of the method 1000, and combinations of operations in the method 1000 may be implemented by, for example, hardware, firmware, a processor, circuitry, and/or a different device associated with the execution of software that includes one or more computer program instructions. The plurality of operations is depicted in the process flow of the method 1000. The process flow starts at operation 1002.

At 1002, the method 1000 includes extracting, by a server system (e.g., the server system 200), textual data related to a screenplay (e.g., the screenplay 302) associated with media content being produced by a first user (e.g., the first user 104). Herein, the screenplay 302 is to be reviewed by a plurality of second users (e.g., the second users 106).

At 1004, the method 1000 includes segmenting, by the server system 200, the textual data into a plurality of sections. Herein, each section of the plurality of sections is displayed to the plurality of second users 106.

At 1006, the method 1000 includes receiving, by the server system 200, one or more user inputs from each of the plurality of second users 106 for each respective section of the plurality of sections.

At 1008, the method 1000 includes determining, by one or more Machine Learning (ML) models (e.g., the ML models 220) associated with the server system 200, user behavior and a set of interpretations based, at least in part, on the textual data and the one or more user inputs.

At 1010, the method 1000 includes generating, by the ML models 220, a prediction indicative of a predicted quality of the media content based, at least in part, on the user behavior and the set of interpretations.

The disclosed method with reference to FIG. 9 and FIG. 10, or one or more operations of the method 900 and 1000 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 102 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations that are different from those which are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claim.

What is claimed is:

1. A computer-implemented method, comprising:
extracting, by a server system, textual data related to a screenplay associated with media content being produced by a first user;
segmenting, by the server system, the textual data into a plurality of sections, wherein each section of the plurality of sections is displayed to a plurality of second users;
receiving, by the server system, one or more user inputs from each of the plurality of second users for each respective section;
determining, by one or more Machine Learning (ML) models associated with the server system, user behavior corresponding to each second user of the plurality of second users and a set of interpretations related to the screenplay based, at least in part, on the textual data and the one or more user inputs; and
generating, by the one or more ML models, a prediction indicative of a predicted quality of the media content based, at least in part, on the user behavior and the set of interpretations.

2. The computer-implemented method as claimed in claim 1, wherein determining the user behavior further comprises:
accessing, by the server system, the one or more user inputs comprising comments, user responses, survey inputs, pausing actions, reason inputs for pausing, and user ratings for story elements of each section of the screenplay from the database;
generating, by the one or more ML models, a comment summary for each section based, at least in part, on the comments for the corresponding section and a set of queries;
determining, by the one or more ML models, a pausing pattern of each second user for each section based, at least in part, on the pausing actions and a reading time of each second user for each section in the screenplay;
determining, by the one or more ML models, a sentiment of each second user for each section based, at least in part, on the comment summary, the user responses, the survey inputs, and the pausing pattern of the corresponding second user, the sentiment being one of positive, negative, or neutral;
computing, by the one or more ML models, a story momentum for the screenplay for each second user based, at least in part, on the sentiment of each second user for each section in the screenplay, the story momentum indicating an engagement of the corresponding second user with the screenplay; and
determining, by the one or more ML models, the user behavior for each second user for each section based, at least in part, on the story momentum and the pausing pattern.

3. The computer-implemented method as claimed in claim 1, wherein determining the set of interpretations is based, at least in part, on determining at least: a set of character-related interpretations, a character appeal of each character, and a set of statistical parameters, wherein the set of interpretations comprises an idea metric, a character centrality metric, a character appeal metric, a character dialogue metric, an originality metric, an emotional impact metric, a clarity metric, and a suspense metric.

4. The computer-implemented method as claimed in claim 3, wherein the set of character-related interpretations comprises a speaking frequency of one or more characters in each section, a mention frequency of the one or more characters, a correlation between the one or more user inputs and the presence of the one or more characters in each section, a centrality of each character, a character importance of each character, a main character, and a character network interpretation.

5. The computer-implemented method as claimed in claim 4, wherein determining the set of character-related interpretations further comprises:
generating, by the server system, a plurality of features based, at least in part, on the textual data and processing criteria, wherein the plurality of features comprises character names of one or more characters in the screenplay, a total word count, words per section, and number of appearances or speeches by each character of the one or more characters;
determining, by the server system, at least one of: a speaking frequency of the one or more characters in each section, a mention frequency of the one or more characters, or a correlation between the one or more user inputs and the presence of the one or more characters in each section based, at least in part, on the textual data and the plurality of features; and
determining, by the server system, a centrality of each character based, at least in part, on the speaking frequency, the mention frequency, and the correlation for the corresponding character in the screenplay.

6. The computer-implemented method as claimed in claim 5, wherein determining the set of character-related interpretations further comprises determining a character importance of each character based, at least in part, on the centrality of the corresponding character and a centrality threshold.

7. The computer-implemented method as claimed in claim 5, wherein determining the set of character-related interpretations further comprises identifying at least a character of the one or more characters as the main character based, at least in part, on the corresponding character being associated with the centrality at least equal to a centrality threshold.

8. The computer-implemented method as claimed in claim 5, wherein determining the set of character-related interpretations further comprises determining a character network interpretation, based at least on:
generating, by the one or more ML models, a character network based, at least in part, on the plurality of features and the one or more characters of the screenplay, wherein the character network comprises a graph of a plurality of nodes and a plurality of edges, wherein each node indicates a character and each edge indicates an interaction between two nodes connected by the corresponding edge;
categorizing, by the one or more ML models, one or more interactions between the one or more characters based at least on an assignment of an interaction type label to each edge in the character network; and
generating, by the one or more ML models, a relationship prediction for the character network interpretation for each character based at least on the categorization of the one or more interactions, the relationship prediction indicating a relationship of each character with every other character of the one or more characters.

9. The computer-implemented method as claimed in claim 1, determining the set of interpretations further comprises determining, by the one or more ML models, a character appeal of each character in each section based, at least in part, on a variation in user ratings and a story momentum in connection with a presence of a particular character.

10. The computer-implemented method as claimed in claim 1, determining the set of interpretations further comprises determining, by the one or more ML models, a set of statistical parameters for the screenplay based, at least in part, on the textual data and the one or more user inputs, the set of statistical parameters comprising a character rating for each character in the screenplay, a section rating, character activity metric, character incidence per section, recommendations, comment categories, positive and negative word trends, momentum lags, favorite character, and recurring issues in the screenplay.

11. The computer-implemented method as claimed in claim 1, wherein generating the prediction further comprises:
identifying, by the server system, a total count of sentences in each section of the screenplay and a count of active sentences in each section based, at least in part, on the textual data of the screenplay;
computing, by the one or more ML models, a kinetic score for each section based at least on the total count of the sentences and the count of active sentences in each section;
computing, by the one or more ML models, a screenplay quality score (SQS) for the screenplay based, at least in part, on the user behavior and the set of interpretations for the screenplay; and
generating, by the one or more ML models, the prediction based at least on the kinetic score for each section and the SQS for the screenplay, wherein the prediction indicating the predicted quality of the media content provide insights on an expected response from one or more third users viewing the media content after a public release of the media content.

12. A server system, comprising:
a communication interface;
a memory comprising executable instructions; and
a processor communicably coupled to the communication interface and the memory, the processor configured to cause the server system to at least:
extract textual data related to a screenplay associated with media content being prepared by a first user;
segment the textual data into a plurality of sections, wherein each section of the plurality of sections is displayed to a plurality of second users;
receive one or more user inputs from each of the plurality of second users for each respective section;
determine, by one or more Machine Learning (ML) models associated with the server system, user behavior corresponding to each second user of the plurality of second users and a set of interpretations related to the screenplay based, at least in part, on the textual data and the one or more user inputs; and
generate, by the one or more ML models, a prediction indicative of a predicted quality of the media content based, at least in part, on the user behavior and the set of interpretations.

13. The server system as claimed in claim 12, wherein to determine the user behavior, the server system is further caused, at least in part, to:
access the one or more user inputs comprising comments, user responses, survey inputs, pausing actions, reason inputs for pausing, and user ratings for story elements of the screenplay for each section of the screenplay from the database;
generate, by the one or more ML models, a comment summary for each section based, at least in part, on the comments for the corresponding section and a set of queries;
determine, by the one or more ML models, a pausing pattern of each second user for each section based, at least in part, on the pausing actions and a reading time of each second user for each section in the screenplay;
determine, by the one or more ML models, a sentiment of each second user for each section based, at least in part, on the comment summary, the user responses, the survey inputs, and the pausing pattern of the corresponding second user, the sentiment being one of positive, negative, or neutral;
compute, by the one or more ML models, a story momentum for the screenplay for each second user based, at least in part, on the sentiment of each second user for each section in the screenplay, the momentum indicating an engagement of the corresponding second user with the screenplay; and
determine, by the one or more ML models, the user behavior for each second user for each section based, at least in part, on the story momentum and the pausing pattern.

14. The server system as claimed in claim 12, wherein to determine the set of interpretations, the server system is further caused, at least in part, to determine at least: a set of character-related interpretations, a character appeal of each character, and a set of statistical parameters, wherein the set of interpretations comprises an idea metric, a character appeal metric, a character dialogue metric, an originality metric, an emotional impact metric, a clarity metric, and a suspense metric.

15. The server system as claimed in claim 14, wherein to determine the set of character-related interpretations, the server system is further caused, at least in part, to:
generate a plurality of features based, at least in part, on the textual data and processing criteria, wherein the plurality of features comprises character names of one or more characters in the screenplay, a total word count, words per section, and number of appearances or speeches by each character of the one or more characters;
determine at least one of: a speaking frequency of the one or more characters in each section, a mention frequency of the one or more characters, or a correlation between the one or more user inputs and the presence of the one or more characters in each section based, at least in part, on the textual data and the plurality of features; and
determine a centrality of each character based, at least in part, on the speaking frequency, the mention frequency, and the correlation for the corresponding character in the screenplay;
determine a character importance of each character based, at least in part, on the centrality of the corresponding character and a centrality threshold; and
identify at least a character of the one or more characters as the main character based, at least in part, on the corresponding character being associated with the centrality at least equal to a centrality threshold.

16. The server system as claimed in claim 15, wherein to determine the set of character-related interpretations, the server system is further caused, at least in part, to determine a character network interpretation, based at least on:
generating, by the one or more ML models, a character network based, at least in part, on the plurality of features and the one or more characters of the screenplay, wherein the character network comprises a graph of a plurality of nodes and a plurality of edges, wherein each node indicates a character and each edge indicates an interaction between two nodes connected by the corresponding edge;
categorizing, by the one or more ML models, one or more interactions between the one or more characters based at least on an assignment of an interaction type label to each edge in the character network; and
generating, by the one or more ML models, a relationship prediction for the character network interpretation for each character based at least on the categorization of the one or more interactions, the relationship prediction indicating a relationship of each character with every other character of the one or more characters.

17. The server system as claimed in claim 12, wherein to determine the set of interpretations, the server system is further caused, at least in part, to determine, by the one or more ML models, a character appeal of each character in each section based, at least in part, on a variation in user ratings and a story momentum based at least in on a presence of a particular character.

18. The server system as claimed in claim 12, wherein to determine the set of interpretations, the server system is further caused, at least in part, to determine, by the one or more ML models, a set of statistical parameters for the screenplay comprising a character rating for each character in the screenplay, a section rating, character activity metric, character incidence per section, recommendations, comment categories, positive and negative word trends, momentum lags, favorite character, and recurring issues in the screenplay, based, at least in part, on the textual data and the one or more user inputs.

19. The server system as claimed in claim 12, wherein to generate the prediction, the server system is further caused, at least in part, to:
identify a total count of sentences in each section of the screenplay and a count of active sentences in each section based, at least in part, on the textual data of the screenplay;
computing, by the one or more ML models, a kinetic score for each section based at least on the total count of the sentences and the count of active sentences in each section;
compute, by the one or more ML models, a screenplay quality score (SQS) for the screenplay based, at least in part, on the user behavior and the set of interpretations for the screenplay; and
generate, by the one or more ML models, the prediction based at least on the kinetic score for each section and the SQS for the screenplay, wherein the prediction indicating the predicted quality of the media content provide insights on an expected response from one or more third users who view the media content after a public release of the media content.

20. A non-transitory computer-readable storage medium comprising computer-executable instructions that, when executed by at least a processor of a server system, cause the server system to perform a method comprising:
extracting textual data related to a screenplay associated with media content being produces by a first user;
segmenting the textual data into a plurality of sections, wherein each section of the plurality of sections is displayed to a plurality of second users;
receiving one or more user inputs from each of the plurality of second users for each respective section;
determining, by one or more Machine Learning (ML) models associated with the server system, user behavior corresponding to each second user of the plurality of second users and a set of interpretations related to the screenplay based, at least in part, on the textual data and the one or more user inputs; and
generating, by the one or more ML models, a prediction indicative of a predicted quality of the media content based, at least in part, on the user behavior and the set of interpretations.
